(19) United States
(12) Patent Application Publication
(10) Pub. No.: US 2024/0010907 A1
(43) Pub. Date: Jan. 11, 2024

(54) Multifunctional Coatings and Chemical Additives

(71) Applicants: feipeng LIU, SPRING, TX (US); Yuning LAI, SPRING, TX (US)

(72) Inventors: feipeng LIU, SPRING, TX (US); Yuning LAI, SPRING, TX (US)

(21) Appl. No.: 17/434,968

(22) PCT Filed: Apr. 15, 2021
(86) PCT No.: PCT/US2021/027426

§ 371 Date: Oct. 6, 2022

(51) Int. Cl. C09K 8/80; C09K 8/88

(52) U.S. Cl. CPC C09K 8/805; C09K 8/88

(57) ABSTRACT

Multifunctional coatings and chemical additives, comprising of lubricant, micro/nano-textured particles, emulsifiers, hydrogel polymers, cross-linking agent to modify the hydrogel polymers, antimicrobial to preserve the bio-based materials, and water solvent, are useful in hydraulic fracturing operation either directly applied on the surface of proppants, or/and mixed with other friction reducer additives to totally or partially substitute the regular friction reducer chemicals, alternatively, as additive components blended or mixed into regular fracturing fluid for easily pumping proppants downhole and stabilizing the pumping pressure; beneficial to the well productivity, effectively suppress and mitigate the risk of respirable microcrystalline dust as the coated materials are transported and handled in the manufacturing plant, terminal, and oil application fields without a need for drying operation on the coating products.

### FIELD OF INVENTION

This invention relates to a multifunctional coating applied on the proppant's surface for reducing the friction of fracturing fluid with the coiled tubing and channels as proppants are transported from the oil application fields to the downhole wellbore fracture zones in the hydraulic fracturing operation. The mixed chemicals can also be added into the fracturing fluid directly as a viscosity enhancer that stabilizes the pumping pressure at a high flow rate, and functionally, as dust suppression agents to mitigate the worker's risks of exposure toward the microcrystalline silica dust. The advantage of the developed recipes over other fracturing fluid and additive chemicals is that the disclosed chemical compositions could be applied by simple blend of proppants with these disclosed chemicals without a need for drying operation in the manufacturing plant, during the transportation, and at the terminals and oil application fields.

### BACKGROUND OF INVENTION

Recently, concerns over fracture conductivity damage by viscous fluids such as guar gums in ultra-tight formations found in the unconventional reservoirs have been promoting the industry to develop alternative fracturing fluid such as slick water and viscoelastic surfactants to booster the hydrocarbon production, however, there have been various technical challenges and practical application issues to be addressed in the operation. Easy wear-out of fracturing operation tools and equipment; dustiness of respirable microcrystalline silica triggering the disease of micro-silicosis of lung cancers; caking and bridging of the grains to grains of the products in the transportation processes; loss of pumping pressure and high demands for high horsepower at high flow rates in the completion and stimulation operation; high costs of newly developed additive chemicals are often mentioned in literature. For examples, resin coated sands and/or self-suspending proppants were described in the U.S. patent applications (20120190593, 20150252253, 20150252252, 20180155614, 20180119006, 20190093000, 20190002756), and U.S. Pat. Nos. 9,868,896, 10,144,865, and 10,316,244. Hydrogel coating was used to coat on the proppant surface for enhancing the oil well productivity in U.S. patent application 20180340117. self-healing, self-cleaning, and self-lubrication multifunction surfaces were claimed by U.S. Pat. Nos. 9,963,597 and 10,011,860, 10,221,321, 10,233,334.

Reduced dust in the product's transportation terminals or oil fields was disclosed in U.S. Pat. No. 10,066,139 that the mineral oil could be used to treat the frac sand surface. U.S. Pat. No. 10,023,790 disclosed a water-soluble electrolyte solution recipe that can be applied on the frac sand surface with spraying to achieve the long-term dust suppression. U.S. Pat. No. 5,595,782, granted to Cole Robert on January of the 21st, 1997, disclosed a suspending sugar/oil emulsion that was used to mitigate the dusty particles. Sugar alcohol ester and its mixture of glycerol chemical components were used to suppress the dust in U.S. patent application of 20190010387. Guar and polysaccharides were also reported to achieve the dust suppression in U.S. Pat. No. 10,208,233.

In other instances, a fracturing treatment involves pumping a proppant mixed with the injected fracturing fluid into a subterraneous formation. During the pumping of the fracturing fluid into the well-bore, a considerable amount of energy may be lost due to the friction between the turbulent flow and the formation and/or tubular goods (e.g. pipes and coiled tubing, etc.). An additional horsepower may be necessary to achieve the desirable treatment. In general, a friction-reducing agent can be used to overcome the drawback from fracturing operation. The friction reducer is a chemical additive that alters the fluid characters so that the fluid can carry the suspended proppants downhole along the pipelines and channels easily with reduced energy losses. Chemical additives used as friction reducers include guar gum, its derivatives, polyacrylamide and polyethylene oxide, and other hydratable materials. For examples, U.S. Pat. No. 3,943,060, disclosed friction reducer chemicals useful in water treatment for viscosity reduction. U.S. Pat. No. 5,948,733, disclosed recipes for controlling fluid loss.

These hydratable additives of friction reducer solution are often sensitive to divalent cations such as calcium and magnesium chloride, and trivalent compounds such as ferric chloride and aluminum trihydrate. Most of these cation's chemical additives are widely contained in the ground water and special treatments of these water might be required to resolve the high dose of total dissolved solids (TDS) issues in the hydraulic fracking operation. Technically, special wastewater treatment technologies such as distillation and reverse osmosis might be used to reduce the water hardness issues. Decreased friction reducer performance in a high TDS brine has been a major challenge for reusing production water in hydraulic fracturing operation. Furthermore, the proppant is abrasive when it is moving along the downhole pipeline at high shearing rates. The abrasiveness of the proppants can cause erosion on the surfaces inside pumps, connected pipes, downhole tubules, and equipment. The lower friction reducer performance in the field causes a spike in pumping pressure for a given flow rate and if sustained, it could ruin the pumping operation.

Another drawback of the friction reducer chemical additives applied to the oil fields is that if the well's bottom hole static temperature is high, a regular polyacrylate sodium acrylamide (PAM) polymer might be subject to a degradation, specially, a modified hydrolyzed (HPAM) hydrogel polymer is required to deliver the desirable transportation performance for proppants with the viscous gel materials. In general, 30% or more polyacrylate sodium sulfonate in components is required to resist the decomposition of the HPAM under the regular well bottom hole static temperature. Improvement of HPAM performance with different emulsion reaction mechanisms was reported. For instance, U.S. Pat. No. 9,783,628 disclosed a synthesized method for preparing a high viscosity emulsion chemical additive that can be used to enhance the hydrate viscosity of fracturing fluid. In another developed additive technologies, U.S. Pat. No. 9,701,883 demonstrated that an addition of silicon polyether could potentially enhance the hydration viscosity when silicon polyether components are mixed with polyacrylate sodium acrylamide polymers. A high TDS tolerance toward the ionic frictional reducer recipes could be realized by an addition of special silicon polyether components. Special cross-linking agents were added in the fluid to reduce the shearing damage created. U.S. Pat. No. 8,661,729 disclosed a hydraulic fracture composition and method in which hydrolyzed polyacrylate sodium acrylamide (HPAM) is imbedded in the resin matrix. U.S. patent application of 2012/0190593 described a self-suspending coating that expands more than 100% of its volume to enhance the transportation capabilities of the suspended proppants in the downhole conditions.

Although many coatings and chemical additive technologies are available, multi-functionalized coatings delivering synergistic effects are still needed. So far, the research has been focused on mimicking one system at a time. In fact, a complex approach with mimicking of natural bio-inspired chemical and microstructure is needed, in which multiple functional coatings to come up with non-trivial designs for highly effective materials with unique properties are conceived and developed. The developed new fracturing fluids, proppant's coating, or additive products should meet the following criteria: 1) it should be slippery, no sticking, and bridging issues in the processes of handling and shipping; 2) if the coating is applied in any processing step, it can mitigate the risk of dust due to the respirable microcrystalline silica; 3) it has enough hydrated viscosity to fracture; 4) it has enhanced hydrophobicity that allows the frac fluid flowed with least pumping pressure and kinetic energy.

Coatings and chemical additives disclosed in this application provide solid answers in a response to the above issues.

### BRIEF STATEMENT OF INVENTION

In the disclosed invention of the developed coatings, it was found that chemical compositions and coating additives could deliver the desirable synergistic effects with a hydro-dual-phobic feature: 1) the disclosed chemical composition and coating can be applied in wet condition without a need for drying; none of arching or bridging during storage and transportation will occur; 2) the coated proppant surface is more slippery and anti-blocking than without the surface treatment of proppants and have enhanced drag/friction reducing capabilities for the fracturing fluid to transport the proppants moving toward the down hole of the wellbore at a high flow rate; 3) alternatively, the coatings can be added into fracturing fluid as a viscosity enhancer at the oil application fields.

By weight percentage (wt.), the chemical composition and coatings are comprising of:
a) lubricant fluid or solvent including mineral oil, hydrocarbon, and alkyl group within a range of 1.0% to 99%,
b) hydrophobic/hydrophilic domain materials such as hydrocarbon wax, non-reactive and/or reactive wax, or particles, micro or/and nano-particle materials, organic or inorganic particles in a range from 0.01 to 40.0%
c) hydrogel polymeric coatings, polymer, and their mixture from 0.01 to 35.0%
d) emulsifiers: 0.01 to 20%
e) others such as antimicrobial and crosslinking agent over (b) or/and (c) or the combination of (b)+(c): 0.0000 to 100%
f) water or/other polar solvent: 0.001 to 99%.

The procedures for formulating the chemical additives are comprising of an addition of lubricants into a container, then, the granular particles or microparticles, micro/nanotextured particles are added into the lubricant solution and the mixed components are heated over 140° F. under stirring conditions until (b) is partially or totally dissolved in the container, then, an emulsifier, and/or a hydrogel polymeric material, or their mixture, are added into the pre-mixed components to create an emulsified shell/core micelle. Alternatively, hydrogel polymers can be added into mixer before emulsifiers. Phase transition materials such as wax and bio-derivative materials are preferred to serve as core layer or bumpy materials. The emulsifiers are served as a shell layer of the emulsion. Alternatively, the hydrogel polymers are served as both the inner and core layers or intermediate layer in the emulsified micelles.

After the combined components of (a)+(b)+(c)+(d) are fully mixed, (e) can be added into the container and continuously blended for an extended time, then, water a polar solvent (f) can be charged into the container to make an adjustment on the viscosity of the final recipes. The mixture is cooled down slowly, then, the mixed solution will create an emulsion complex, packed in a container, and stored for late use.

To a separately mixed container, the proppants, are first added, then, coatings, obtained from the above processes, are mixed into the container without a need for drying the blended components. The formulated chemical compositions and additives can be used as a coating directly applied to the proppant's surface. Alternatively, it can be added into the fracturing fluid as a friction reducer agent directly with or without a friction reducer in liquid or in powder. A spraying operation can be applied to the coating at the terminal or manufacturing facilities. The coating materials can be sprayed on the surface of proppants served as dust suppression agent, anti-blocking agent, friction reducer agent, and scale-inhibition agent that benefit the completion and well stimulation. The details in the recipe preparation and processing disclosure for preparing the coatings and additive emulsion are illustrated in the subsequent section in the examples 1 to 40 in detail.

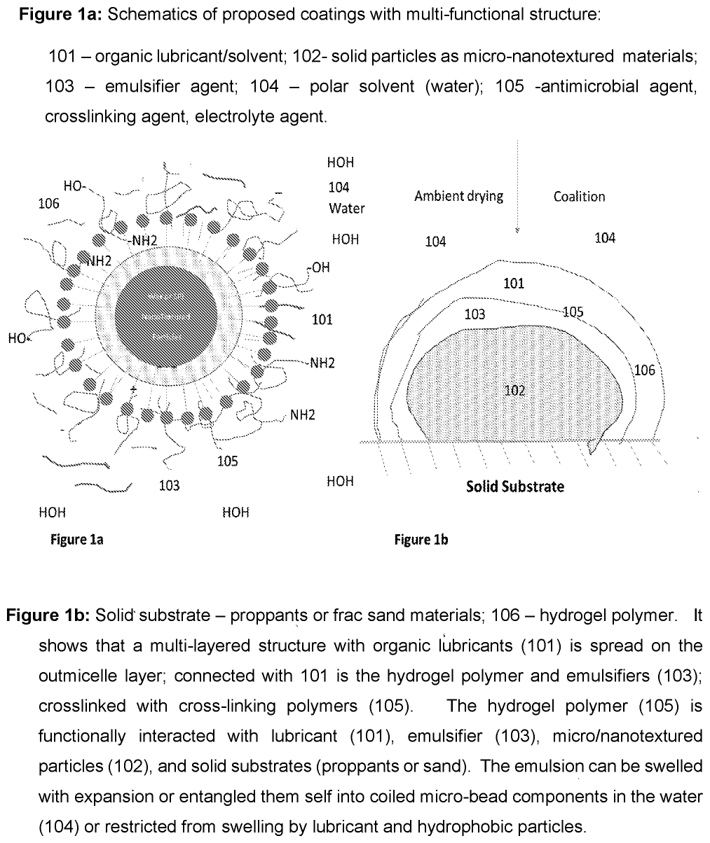

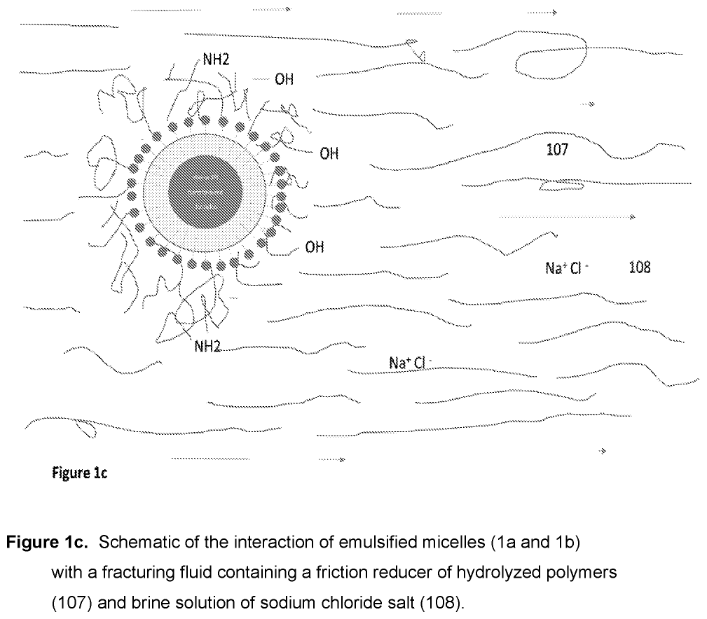

FIG. 1b: Interaction of solid substrate-proppants or frac sand materials with macro/micro dual phobic spheres: 106-hydrogel polymers. It is shown that a multi-layered structure with organic lubricants (101) is spread on the out-micelle layer; connected with 101 is the hydrogel polymer and emulsifiers (103); cross-linked with cross-linking polymers (105). The hydrogel polymer (105) is functionally interacted with lubricant (101), emulsifier (103), micro/nanotextured particles (102), and solid substrates (proppants or sand). The emulsion can be swelled with expansion or entangled them self into coiled micro-bead components in the water (104) or restricted from swelling by lubricant and hydrophobic particles.

### DETAILED DESCRIPTION OF THE INVENTION

Of the materials used for hydraulic fracking operation in the oil and gas energy exploration, two most important key materials are granular materials such as frac sand and fracturing fluid added with friction reducer additives included. Fracturing sand materials are used for propping and opening the downhole rocks and creating fracture in the formation, fracturing fluid for transporting the frac sand and/or proppants delivered into the desirable destination of targeted fracture opening. Technically, it requires that the proppants have defined shape, crush strength under the special downhole closure stress, appropriate particle size, and competitive price. Preferred proppant's materials should meet API standards or meet specified customer on-demand request per mutual agreements. Typical proppant's materials include the North White Sand, Brady brown sand, local basin sand, ceramics, and bauxite spherical materials.

Hydrogel Polymers: More specifically, since the proppant product has a higher density than water, any proppant suspended in the water will tend to separate quickly and settle out from the water very rapidly. To help its suspension in the transportation to the wellbore destination, it is common to use a viscosity-increasing agent for increasing the viscosities of used fracking water. Common practices in current manufacturing technologies disclosed are to use hydrogel polymers such as polyethylene glycol, polyacrylate and polyacrylamide polymers and/or their copolymers either added into the fracturing fluid, in which, the use of additional surfactants is involved. Powder polymers are conventionally used in these applications due to the high polymer concentration available in the form as compared to the solution polymers with reduced shipping cost.

In general, the use of copolymers of acrylamide with aqueous cationic and anionic monomers could prevent frictional loss in well completion and stimulation as disclosed in various U.S. patents. The dose level of frictional reducer agents added into the fracturing fluid is typically added as a fraction reducer additive that allows maximum fluid to flow with a minimized pumping pressure and energy by using a dose range of from 0.20 to 2.0 gallons of friction reducer polymer per 1000 gallons of water (gpt). The friction reducer solution has a low hydrated viscosity of 3 to 100 (cps).

Hydrogel polymers are commercially available in the market. For examples, there are several brands of SNF products, such as FLOPAM DR 6000 and DR 7000, that can be incorporated directly into fracturing fluid¹. Both polymers are anionic polyacrylamide. Alternatively, FTZ620, FTZ610, and LX641 polyacrylate acrylamide polymers, manufactured by Shenyang JiuFang Technology Ltd., are also useful polymers as alternative HPAM as friction reducer and coating ingredients². Other polyacrylate and acrylamide polymers with cationic and nonionic molecular structure, are also potential candidates as hydrogel polymers. The structure of hydrolyzed polyacrylate sodium acrylamide can be linear or branched with dendrimers having hyperbranched polyester amide structure, other water-soluble polymers, such as polyvinyl alcohol (PVOH) and polyethylene glycol, are also potential candidates as substitute polymers of HPAM. ¹https//www.snf.us/wp_contest/cploads/2004/08/Floppam_Drag.reducer.pdf.² https//www.if_chinapolymer.com.

A further benefit of coating the proppants with the hydrogel polymers is that the fine particles such as crystalline silica dust can be mitigated to reduce the risk of workers exposed toward the respirable microcrystalline silica dust for chronic diseases and reducing contamination of the working environments. The percentage dose level of hydrogel polymers in the recipes will be in a range of within 0.01 to 35.0%, preferred 0.001 to 15.0%, more preferred 0.001%, 5.0%.

Lubricant: The synthesis processes of the HPAM polymers are involved in an inverted emulsion. Mineral oil or saturated hydrocarbon (kerosene) is, in general, used as a key solvent for preparing the HPAM friction reducer emulsion. As a result, HPAM hydrogel polymer is dispersible in the lubricant. Lubricants or oils are comprising of the derivatives from petroleum crude oil, containing saturated hydrocarbon and alkyl group from C6 to C25. Alternatively, the lubricants can also be originated from the bio-derivative resource such as corn, soy bean, sunflower, linseed oil containing the long chain alkyl components. The lubricants can also be synthetic oil chemicals made of reactive ester or hydroxyl functional alkyl chains or saturated hydrocarbons coupled with silane coupling agent or having silicon functional groups.

A broad definition of lubricants could be found in an URL link³. It is defined as a substance, usually organic, introduced to reduce friction between surfaces in mutual contact, which ultimately reduces the heat generated when the surfaces move. The dose applied in the chemical compositions for lubricants is added in a range from 1.0 to 90%. A typical mineral oil that can be used is a white mineral oil labelled as 70 Crystal Plus white mineral oils, manufactured by STE Oil Company, TX, USA. It is a series of derivatives of petroleum crude oils. Alternatively, soybean oil and linseed oil, or synthesis silicon oil can be used as lubricants. Other examples of lubricants include ethylene bisstearic acid, amide, oxy stearic acid, amide, stearic acid, stearic acid coupling agents, such as an amino-silane type, an epoxy-silane type and a vinyl-silane type and a titanate coupling agent. ³https/en.wiki.pedia.org/wiki/lubricant.

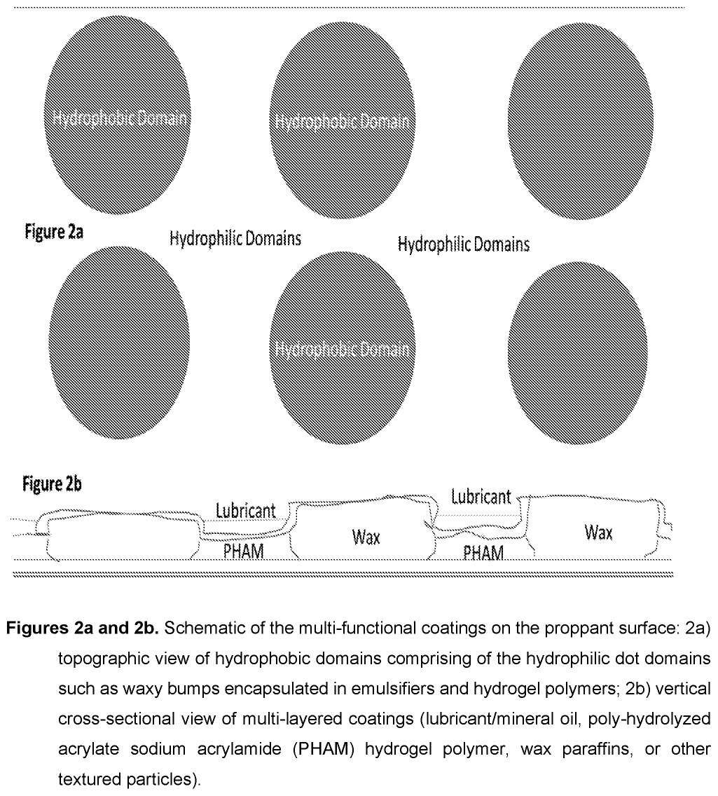

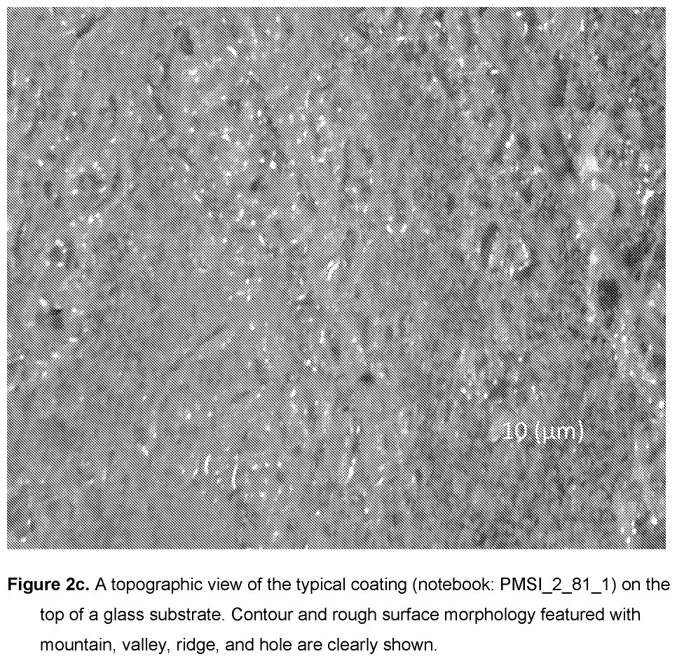

Micro/Nanotextured Domains: Of the disclosed chemical composition and emulsion coatings as shown in FIG. 2a, 2b, 2c, randomly distributed micro/nanotextured domains can be created by incorporating powder, nanoparticles, or nano-fiber materials on the coating surface. Instead of having a smooth surface, the coatings have an uneven and rough surface. Spherical inorganic mineral fillers or organic nanosized or micro-sized filler materials are potential textured materials as the dot domain's materials. One of identified cost-effective chemical additives is the petroleum paraffin. Others, such as soy protein isolate (SPI), are also preferred candidates as nanotextured domain materials. Morphological texture of ridge, concave, convex, and valley's features of coatings could be useful to construct the disclosed coating materials with micro-tips and bumps generated by the waxy spheres and/or dots to create an enhanced hydrophobicity and anti-blocking capability on the coated proppants.

Another benefit with waxy materials is that wax is cost-effective as hydrophobic domain materials and easy to be emulsified into coatings. It has a diverse class of organic compounds that are lipophilic, malleable solids near ambient temperatures, including higher alkanes and lipids, melting to give low viscosity liquids. Waxes are insoluble in water but soluble in organic and nonpolar solvents. Natural waxes of different types are produced by environmentally friendly plants. For example, Carnauba wax, also called Brazil wax and Palm wax, originally from the leaves of the palm, is consisting mostly of aliphatic esters (40 wt. %), diesters of 4-hydroxycinnamic acid (21.0 wt. %), ω-hydroxycarboxylic acids (13.0 wt. %), and fatty alcohols (12 wt. %). The compounds are predominantly derived from acids and alcohols in the C26-C30 range. Distinctive for carnauba wax is the high content of diesters as well as methoxy-cinnamic acid⁴. ⁴https://en.wikipedia.org/wiki/Carnauba_wax.

Paraffin waxes are hydrocarbons, mixtures of alkanes usually in a homologous series of chain lengths. They are mixtures of saturated n- and iso-alkanes, naphthene, and alkyl- and naphthene-substituted aromatic compounds. A typical alkane paraffin wax chemical composition comprises hydrocarbons with the general formula CₙH₂ₙ₊₂ and C₃₁H₆₄. The degree of branching has an important influence on the properties. Microcrystalline wax is a lesser produced petroleum-based wax that contains higher percentage of iso-paraffinic (branched) hydrocarbons and naphthenic hydrocarbons. The candle and paraffin wax are commercially available in the commodity market.

Synthetic waxes are primarily derived by polymerizing ethylene. Alpha olefins are chemically reactive because they contain a double bond which is on the first carbon. The newest synthetic paraffins are hydro-treated alpha olefins which removes the double bonds, making a high melt, narrow cut and hard paraffin wax. The wax is a very hydrophobic material. It has melting points in general above 35° C. or more. More specifically, the melt points of the wax are above 55° C. It has a measured water contact angle between 108 and 116(°) (Mdsalih, et al. 2012). The percent wax quantities added into the mixture of designated recipes should be in a range from 0.01% to 15.0%, more preferred less than 5.0%. Other typical synthesis waxes include reactive wax such as ethylene stearamide, bis-ethylene stearamide, and their blends with other wax or solid lubricant materials that have lubricants and slippery characters. Besides wax, other nano-particles, such as polylactic polymers, SPI, nanofillers, lipids, sweet rice, and other bio-derivatives, might be used as macro/nanotextured materials mixed together with wax to achieve desirable hydrophobicity and hydrophilicity. Hydro-dual phobic domain materials are referred to the materials that can be described as a material that behaves as hydrophilic, also hydrophobic with a dual-phoblicity. It can be a two system by a synergistic blend or one system chemically modifying a solid surface with multifunctional attributes. For example, a silane coupling surface treatment will allow the surface of modification to become either hydrophilic or hydrophobic, leading to be a hydro-dual-phobic. As such, as the modifying surface is contact with water, it will tend to expose itself with hydrophilic attributes. As it is attached with non-polar solvent, it will tend to expose its wax or alkyl functional groups on the surrounding environments. As such, the coated molecular components can be adapted to the solvents or air with appropriate fitness to the systems.

Emulsifier: An emulsifier is a surfactant chemical. It can be cationic, anionic, nonionic, zwitterionic, amphiphilic having linear long chain, branched with di-functional, tri- or multi-functional star's structures, consisting of a water-loving hydrophilic head and an oil-loving hydrophobic tail. The hydrophilic head is directed to the aqueous phase and the hydrophobic tail to the oil phase. The emulsifier positions itself at the oil/water or air/water interface and, by reducing the surface tension, has a stabilizing effect on the emulsion. In addition to their ability to form an emulsion, it can interact with other components and ingredients. In this way, various functionalities can be obtained, for examples, interaction with proteins or carbohydrates to generate connected clusters both chemically and physically.

Typical emulsifiers include stearic acid oxide ethylene ester, sorbitol fatty acid ester, glyceryl stearate acid ester, octadecanoic acid ester, combination of these esters, fatty amine, acid chemical additives and compounds, alkylphenol ethoxylates such as Tergitol NP series and Triton x-100 from Dow chemicals, glycol-mono-dodecyl ether, ethylated amines and fatty acid amides. For example, SPAN 60: polysorbitan 60 (MS) and PEG100 glyceryl stearate MS are two typical emulsifiers used for emulsion coatings in cosmetics industries. Typical emulsifier is branched as polyoxide-ethylene parts, groups found in the molecules such as monolaurate 20, monopaimitate 40, monostearate 60, monooleate 80, et al. with HLB from 4.0 to 20.0, preferred around 10.0 to 17.0.

Dose levels of added emulsifiers in the emulsion can be within a range of 0.01% to 5.0%, more specially less than 3.0%. The emulsifiers are water insoluble and only dispersible. It is only dissolved in hot water. Wax and SPI or polyhydroxy sugar compounds can be included as core materials in the micelle structure by being added as emulsifiers. Here, the emulsifiers serve as the shell components in the micelle structure.

The emulsifiers used in this coating are critical components. As shown in FIG. 2b, it has its hydrophilic heads toward the outside water loving phase and create strong interaction with water solvent. Meanwhile, it has its hydrophobic long chain tail portion toward the waxy sphere as shell materials for the micelle. Waxy sphere is potentially encapsulated into the micelle of the emulsion with emulsifiers. In addition, the functional groups of hydrogel polymers from its —NH₂ might have cationic interaction and —OH with hydrogen bonding. The —CH₂CH₂— functional groups from mineral oil might have excellent interaction. Also, the functional groups of alkyl chains from mineral oil might have a strong interaction with both emulsifiers and hydrogel alkyl chain groups. The applicants believe that the interaction among these chemical compositions makes the coatings very complicated.

Cross-linking Agent: To enhance the stiffness or strength of the hydrogel polymers, cross-linking agents can be added in the mixed components. Typical cross-linking agents added can be polymers with reactive functionalities. A typical polymer, such as polyurethane dispersive agents, containing the un-saturated UV curable cross-linker agents, could be added into the chemical component's system. Reaction of cross-linking agents can be chemically cross-linked with non-reversable connections in nature or reversable with hydrogen bonding, pending upon the blended component's condition. Alternatively, chemicals, containing epoxy, amine, amine or reactive aldehyde, glutaraldehyde, hexamine, and hydroxy-amine functional groups and compounds, could be added into the coatings or/and solutions. Isocyanate and silane coupling reactive cross-linked polymers can also be used. The preferred dose level of cross-linking chemicals is less than 10.0% by total wt., more preferred less than 5.0%.

Antimicrobial Agent: As biomaterials or its derivatives are incorporated in the recipes, antimicrobial agent, preservatives, preventing the bio-materials from bacteria or micro-fermentation, can be added in the recipes, common additives, including glutaraldehyde, formaldehyde, benzyl-C₁₂₋₁₆-dimethylbenzyl ammonium chloride, fatty amine, alternatively, inorganic antimicrobial materials, such as copper sulfates, copper oxide nano powder, can be used.

Water: Water is assumed to be a key component for preparing the emulsion as media and dilute agent to hydrate and adjust the coating into appropriate viscosity. Preferred viscosity of the final coatings will be in a range of 5 to 50 (cps) at the ambient temperature, the dose level of the water added will be in a range of within from 80.0% to 97.0% in total, preferred larger than 85.0%.

Procedures for preparing the chemical composition and additives disclosed herein relate to the recipes for a multi-functional coating, comprising a multi-layered or hybrid shell and core structure having a desirable synergistic effect to the fracturing fluid. It is not wishing to be limited by theory, applicants believe that the added components following a special procedure form a mixed unknown and undefined multi-layer and a micro-micelle emulsion structure that can deliver special multi-functional performance in a response to the product's performance request. The coating chemical components can be described as that a phase transition material, such as petroleum wax, biomaterials, and/or granular materials, organic or inorganic derivative particle materials (labelled 102), sized in diameters from 0.000001 (micron) to 1000 (micron), could be dissolved or dispersed in the mineral oil (101) by heating and re-condensed and crystalized back into solid bump and particles as the mixed component's temperature is below the melting temperature of mixed components.

The non-polar lubricant solvents such as mineral oil and alkyl group are saturated carbon and unsaturated hydrocarbons in the range of from C6 to C18 (101), also, included in the recipes are saturated carbons in the range of C12 to C26 in the range and mostly alkanes, cycloalkanes, and various aromatic hydrocarbons (102). It can be classified as paraffin, naphthenic, and aromatic. The preferred heating temperature for the mixed chemicals can be as high as 140° F., then, the surfactants or emulsifiers (103) can be added into the mixed solution, resulting in a uniform emulsion with multi-layered shell/core structure.

Finally, a hydrogel polymer (106) and cross-linking agents (105) are added into the solution. The micelle structure disclosed here is just for demonstration only. The actual micelle structure might be a hybrid one with an ambiguous intermediate layer or interface instead of a clear shell and core's structure. The wax particles as the core of the micelles are encapsulated within the emulsifier molecules. The emulsifier molecules are hybridized with hydrogel HPAM polymers extended toward the water phases. The emulsifier molecules play essential roles in dispersing the wax or other micro-nanotextured particles and fiber materials in the hydrogel polymers and solvents temporally. Meanwhile, it also allows the wax or other textured particles to migrate and suspended on the top of the coating layers. As a result, the hydrophobic coating domains and bump dots can be generated.

After being blended for 5 (minutes), the mixed components can be charged with polar solvents such as water (104) into the mixture, Brookfield viscosity of the mixed materials can be determined at a spindle rotation speed of 6,12, 30, and 60 (RPM), then, the coating materials are sealed in the package for late use. A schematic of emulsion in shell/coremicelle structure is illustrated in FIG. 1a.

Alternatively, the multifunctional coating materials of micelles can be added into a fracturing fluid such as frictional reducer solution incorporated with certain percentage of brine solutions such as 2.0% sodium chloride or positum chloride (NaCl-108), in which a frictional reducer agent (107 FIG. 1c) is dispersed in water (104). The viscosity of mixed components can be determined with a Brookfield viscosity meter or Fann Viscometer and described in the following explanatory examples.

If the coating is sprayed or blended with proppants, the surface of the coatings could be conceptually simplified with a patch of typical domains: a) hydrophobic and b) hydrophilic domains originally from the mixed ratio of different chemical compositions and their relative polarities of hydrophobicity and hydrophilicity in FIG. 2a in a horizontal view (Liu, et al. 1995). For instance, related to the hydrogel components such as hydrolyzed polyacrylate sodium acrylamide (HPAM) polymers are considered as hydrophilic domain materials, in contrast, the waxy materials as hydrophobic in the mixed domain surface.

As shown in FIG. 2b, the surface of the coatings presents rough and uneven profile across the multifunctional coating systems vertically. The hydrophobic domains are tipped out from the top coating layer. Protruded hydrophobic domains (waxy tips or bumps) are randomly dispersed within the hydrogel polymer matrices immersed with a thin layer of mineral oils. Wax, mineral oil, and hydrogel polymers are slippery additive materials. A coating applied on the proppant surface with these chemicals is unique as a slippery coating and additive material if coated on the surface of proppants or as additives added into the regular fracturing fluid containing the friction reducer.

The proppants used in the disclosed invention are referred to as these materials such as North white frac sand, brown sand, local basin sand, ceramics, bauxite, glass sphere, ceramic sphere, and hollow spheres, saw dust, walnut shell particle materials. These materials can be made with organic or inorganic or their hybrids. The particle size can be 100 mesh, 40/70, 30/50, 20/40 per API specification or 40/70, others pending upon the customer specification. Regular and common available equipment can be used for mixing the proppants with the emulsion such as rotary mixer and nozzle spraying.

As shown in FIG. 2c, the surface morphology of a typical coating, featured with mountains, valleys, hills, and ridges, meandering rivers, deep valley, and pinholes, is clearly demonstrated under the micro-optical scopes, however, different from a lotus leaf and Nepenthe pitcher plant, the proppant surface could be structured with various textured ridge, top hills, and isolated islands of waxy spots and bumpy dots in a randomly distributed pattern.

These island areas, comprising of the waxy or/and SPI components as the top layer, are surrounded by hydrogel polymers prepared with free radical polymerization through an inverted emulsion process. The hydrogel polymers are compatible with the lubricants and make the coating top layer of the coating surface smooth. Therefore, the lubricant and mineral oil can penetrate itself or sink itself in the hydrogel polymer matrices to grant the coated surface flexible to each other between adjacent grains of proppants. Since the lubricant/mineral oil has a low surface tension (22 dynes/cm), it is believed that the coating disclosed here potentially grants its self with anti-sticking and anti-blocking attribute important during the products handling and transportation.

Brine solution and total dissolved solids (TDS) of brine is referred as to the water solution containing salt cationic particles or elements. In the available water resource of oil field, the water, in general, contains quite bit of cationic salts such as calcium and magnesium ion. 2.0% to 10.0% sodium chloride or potassium chloride are prepared in hydraulic fracturing operation to reduce the percentage swelling created by clays. Since the cationic salts are positively charged, interaction of cationic salts such as calcium cations with friction reducer of the fracturing fluid has always been a challenging issue. Potential drawbacks of cationic ions are that it precipitates the polyacrylate acrylamide polymers and makes the polymers coiled together and dramatically reduce the hydrated viscosity of fracturing fluid. As a result, more HPAM chemicals are needed to overcome the drawbacks of the precipitation of cationic ion before the viscosity of the fracturing fluid can be regained.

Total dissolved solids (TDS) is one critical parameter used to define the qualities of water for the cationic strength. Alternatively, another parameter is the electronic conductivity. Both are positively related to each other. In addition, solution pH value is also an important parameter that controls the rheology of fracturing fluid. In general, the preferred pH value of HPAM is slightly higher than 7.0. The chemical composition and coatings with high salt tolerance capabilities are preferred. Various advantages of disclosed recipes and formulation will be further illustrated in the explanatory examples 1 to 40.

### Explanatory Examples

Example 1: To a 250 (m L) beaker, charged 260 (g) of tap water, turned the magnetic stir bar, then, charged 1.09 (g) of LX641, a commercially available HPAM (concentration of 35.0%) for 5 (minutes), then, charged 10.85 (gram) of sodium chloride (2.0%) to prepare a friction reducer (FR) solution with 2.0% sodium chloride and 0.20% FR solution concentration. The solution was transferred into a 600 (mL) of beaker, then, another 270.0 (gram) of tap water was mixed in the beaker and blended for another 10 (minutes) and left overnight before measuring the rheological properties of the blended solution. It was labelled as PMSI_2_54_1 in the notebook. This is the standard FR solution referred in this invention for comparison purpose.
Example 2: To a 250 (mL) of beaker, 260 (g) of tap water was added, then, a magnetic stir bar was turned, then, 0.785 (g) of LX 641, a commercially available HPAM (concentration of 35.0%) for 5 (minutes), transferred the mixed components into a 600 (mL) of beaker and charged 10.5 (gram) of sodium hydroxide to create a FR concentration of 0.15% and 2.0% sodium chloride. The FR solution was labelled as PMSI 2_53_1.
Example 3a: To a 250 (mL) of beaker, 15 (g) of Crystal Plus 70T STE mineral oil was charged into the beaker and a magnetic stir bar was turned on. 2.0 (gram) candle wax was charged into the beaker, then, the beaker was heated. At a solution temperature of 113° F., the wax was melted. The mixture was continuously heated until it had a solution temperature of 127° F. 1.0 (gram) of a hydrolyzed polyacrylate sodium acrylamide (HPAM)polymer in powder (FTZ 610), commercially available, was charged into the beaker, then, blended for at least another 5 (minutes). 3.0 (gram) of an emulsifier agent, called polysorbitan 60 monostearate (MS), was charged into the beaker and blended for another 15 (minutes) at 140° F., then, charged 79.0 (gram) of tap water into the beaker. The mix was continuously blended for another 5 (min.) before transferred into a sealed plastic cup for late use. The sealed sample was left on the counter top to make observation for over a week without a precipitation and phase separation. The final prepared recipe had a white color as an emulsion coating. The sample was labelled as PMSI_1_76_2.
Example 3b: To a 250 (mL) of beaker, 19 (g) 70T STE mineral oil was charged into the beaker and a magnetic stir bar was turned on. 2.0 (gram) candle wax was charged into the beaker, then, the beaker was heated so that the wax could be melt. At a solution temperature of 113° F., the wax was melted. The mixture was continuously heated until it reached an oven temperature of 127° F. 1.0 (gram) of a hydrolyzed polyacrylate sodium acrylamide (HPAM) polymer in powder, commercially available, was charged into the beaker, then, blended for at least another 5 (minutes). 3.0 (gram) of an emulsifier agent, called polysorbitan 60 monostearate (MS), was charged into the beaker and blended for another 15 (minutes) at 140° F., then, charged 89.5 (gram) of tap water into the beaker, the mixture was continuously blended for another 5 (minutes) before transferred into a sealed plastic cup for late use. The sealed sample was left over for over a week without a precipitation and phase separation. The final prepared mixed solution showed a white color as an emulsion coating. The sample was labelled as PMSI_1_76_9.
Example 3c: A blend of the emulsion from example 3a and example 3b at a wt. ratio of 50:50 is comprising of a recipe in percentage as follows: 70 T STE mineral: 8.50%; Polysorbitan 60 MS: 1.50%; candle wax: 1.0%; ZFT 610: 2.50%; and water: 88.50%. The final product showed white color as emulsion coating by which the prepared sample was labelled as PMSI_1_89_1.
Example 3d: To a 250 (mL) of beaker, 80.0 (gram) of PMSI_2_89_1 (example 3c) was charged into the beaker, then, 120.0 (gram) of tap water was added into the beaker and blended for 5 minutes to dilute the PMSI_1_89_1 into a similar solution with less concentration. The final emulsion product had the following recipe in wt. %: 70 T STE mineral oil: 2.330%; ZFT 610: 0.140%; PS 60 MS: 0.410%; candle wax: 0.270%; water: 96.850%. The tested sample was labelled as PMSI_1_107_1.
Example 3e: To a 250 (mL) of beaker, 17.0 (gram) of 70 T STE mineral oil was added into the beaker, then, a magnetic stir bar was used to stir the mineral solvent, 2.0 (gram) of candle and 2.348 (gram) of Polysorbitan 60 MS were added into the beaker together. The mixture was heated to 140° C. for 5 minutes to make sure that the candle wax was totally dissolved into the solution. Due to observed clumping stuff on the wall of glass beaker, 177.20 (gram) of tap water was added into the beaker, then, 0.250 (gram) of PEG 100 glyceryl stearate ester was added into the beaker and continuously blended for another 5 (minutes). The resulted emulsion recipe was labelled as PMSI_1_95_1.
Example 3f: To a 600 (mL) of beaker, 101.9 (gram) of PMSI_1_89_1 was blended with 158.0 (g) of PMSI_1_95_1 together. The final emulsion had a total wt. of 259.9 (gram). The product showed excellent stabilities at room temperature and the mixed components were labelled as PMSI_1_115_1.
Example 3g: To a 250 (mL) of beaker, 16.9 (gram) of 70T STE mineral oil was added into the beaker, then, 1.99 (gram) of candle wax was also added into the beaker. The mixed solution was stirred and heated simultaneously until the solution temperature reached 140° F. 2.592 (gram) of polysorbitan 60 MS NF and 0.153 (gram) of PEG100 glyceryl stearate were charged into the beaker together. All components were blended for at least 5 (minutes), then, 0.947 (gram) of LB 206 (35.0%), a commercially available HPAM solution, was added into the beaker and continuously blended for another 5 minutes, then, 220.0 (gram) of tap water was added slowly into the mixed components. As the viscosity of the mixed components increased, another 206.8 (gram) of tap water was added into the emulsion. All these mixed components were blended for another 5 (minutes), then, the mixture was cooled down to room temperature. The sample was labelled as PMSI_1_145_1.
Example 4a: To a 250 (mL) of beaker, 22.398 (g) 70T STE mineral oil was charged into the beaker and a magnetic stir bar was turned. 2.457 (gram) candle wax was charged into the beaker, then, the beaker was heated so that the wax could be melt. At a solution temperature of 113° F., the wax was melted. The mixture was continuously heated until it reached a water bath temperature of 127° F. 2.457 (gram) of an emulsifier agent, called polysorbitan 60 monostearate (MS), was charged into the beaker and blended for another 15 (minutes) at 140° F., then, 1.143 (gram) of a hydrolyzed polyacrylate sodium acrylamide (HPAM) polymer in powder (FTZ620), commercially available, was charged into the beaker, then, blended for at least another 5 (minutes), charged 224.0 (gram) of tap water into the beaker, then, continuously blended for another 5 (minutes) before transferred into a sealed plastic cup for late use.
Example 4b: To a 250 (mL) of beaker, 101.07 (gram) of PMSI_2_64_1 emulsion was added into the beaker, then, 2.159 (gram) of water-soluble acrylate polyurethane dispersion was charged into the beaker. Both two components were blended for about 5 (minutes) before sealed in a plastic jar for late use. The final cross-linkable emulsion was labelled as PMSI_2_80_2.
Example 5: To a 250 (mL) of beaker, 15.232 (g) 70T STE mineral oil was charged into the beaker and a magnetic stir bar was turned on. 1.766 (gram) candle wax was charged into the beaker, then, the beaker was heated so that the wax could be dissolved in lubricant/mineral oil. At a solution temperature of 113° F., the wax was melted. The mixture was continuously heated until it reached at a bath temperature of 127° F. 2.308 (gram) of an emulsifier agent, called polysorbitan 60 monostearate (MS) plus 0.139 (g) of PEG 100 glyceryl stearate was charged into the beaker and blended for another 15 (minutes) at 140° F., then, 0.442 (gram) of a hydrolyzed polyacrylate sodium acrylamide (HPAM) polymer in powder (FTZ620), commercially available and a sweet rice flour product, was charged into the beaker, then, blended for at least another 5 (minutes), then, charged 279.9 (gram) of tap water into the beaker. The mixture was continuously blended for another 5 (minutes) before transferred into a sealed plastic cup for late use overnight. The final prepared solution had a white color as emulsion coatings labelled as PMSI_2_59_1.
Example 6: To a 250 (mL) of beaker, 11.150 (g) 70T STE mineral oil was charged into the beaker and a magnetic stir bar was turned. 1.33 (gram) soy protein isolate (SPI) was charged into the beaker, then, the beaker was heated so that the mixture temperature could be increased until 140° F. 1.720 (gram) of an emulsifier agent, called polysorbitan 60 monostearate (MS) and 0.110 (gram) of PEG100 glyceryl stearate, were blended and charged into the beaker and blended for another 15 (minutes) at 140° F., then, 1.143 (gram) of a hydrolyzed polyacrylate sodium acrylamide (HPAM) polymer in powder (FTZ620), commercially available, was charged into the beaker. The mixture was continuously blended and heated until 90° F., blended for at least another 5 (minutes), charged 245.9 (gram) of tap water into the beaker, then, continuously blended for another 5 (minutes) before transferred into a sealed plastic cup overnight before use. The final prepared mixed solution had a white color as an emulsion coating labelled as PMSI_2_87_1.
Example 7: To a 600 (mL) of beaker, 400 (gram) of tap water was added into the beaker, then, 18.85 (gram) of solid in powder was added into the beaker. Of these 18.85 (gram) of solids, there are 16.965 (g) was Calcium chloride in powder, 0.943 (g) sodium chloride, and 0.943 (g) potassium chloride. The created solution was transferred to a 500 (mL) of plastic jar after the solids were totally dissolved in the tap water. The total solids content was 4.7% as a standard high salinity brine solution for comparison purpose. The sample ID was labelled as PMSI_2_89_1.

A summary of the recipes described in examples 1 to 7 is listed in table 1.

TABLE 1
Summary of Coating Recipes Used in examples 1 to 7 by wt. %

| | Description | Exam 1 | Exam 2 | Exam 3a | Exam 3b | Exam 3c | Exam 3d | Exam 3e |
|---|---|---|---|---|---|---|---|---|
| | of Component | PMSI_2_ | PMSI_2_ | PMSI_1_ | PMSI_1_ | PMSI_1_ | PMSI_1_ | PMSI_1_ |
| Chemical items | Function ( [symbol] ) | 54_1 | 53_1 | 76_2 | 76_9 | 89_1 | 107_1 | 95_1 |
| Tap Water | Solvent | 47.965 | 49.972 | | | | | |
| Crystal Plus 70 | Lubrication and | | | 15.0 | 19.0 | 8.5 | 2.33 | 8.5 |
| T [symbol] Mineral Oil | nonpolar | | | | | | | |
| | chemicals | | | | | | | |
| Polysorb [symbol] | Emulsifier for | | | 3.0 | 3.0 | 1.5 | 0.41 | 1.174 |
| 60 MSNF | encapsulation | | | | | | | |
| PEG100 Glyceryl | Emulsifier for | | | | | | | 0.25 |
| Stearate | encapsulation | | | | | | | |
| Soy Protein | Porous | | | | | | | |
| Isolate | microparticles | | | | | | | |
| | for coating | | | | | | | |
| | surface textures | | | | | | | |
| Candle Wax | Microparticles | | | 2.0 | 2.0 | 1.0 | 0.27 | 1 |
| | for slippery | | | | | | | |
| | coating surface | | | | | | | |
| | texture generation | | | | | | | |
| ZFT [symbol] 10 | Hydrogel | | | 1.0 | 1.0 | 0.5 | 0.14 | 0.5 |
| | Polymer | | | | | | | |
| ZFT [symbol] 20 | Hydrogel | | | | | | | |
| | polymer | | | | | | | |
| LX 641 | Liquid HPMA | 0.200 | 0.1500 | | | | | |
| | (35.0%) | | | | | | | |
| LB 206 | HPAM in 35% | | | | | | | |
| | Concentration | | | | | | | |
| Sweet Rice Flour | Crosslinking | | | | | | | |
| | agent | | | | | | | |
| Acrylate Urethane | Crosslinking | | | | | | | |
| binder | agent | | | | | | | |
| NaCl | Mono [symbol] | 2.002 | 2.0103 | | | | | |
| | electrolyte | | | | | | | |
| CaCl₂ | Cationic | | | | | | | |
| | Electrolyte | | | | | | | |
| KCl | mono [symbol] | | | | | | | |
| | electrolyte (Clay | | | | | | | |
| | stabilizer) | | | | | | | |
| Tap Water | Solvent | 49.829 | 47.8665 | 79 | 75 | 88.5 | 96.85 | 88.58 |
| | Sub Total (wt. %) | 100.00 | 100.00 | 100.00 | 100 | 100 | 100 | 100.00 |
| | Key Ingredient | 2.20 | 2.16 | 21.00 | 25.00 | 11.50 | 3.15 | 11.42 |
| | Wt. % | | | | | | | |
| | Solids % | 2.202 | 2.1506 | 6.0 | 6.00 | 3 | 0.82 | 2.924 |
| | Description | Exam 3f | Exam 3g | Exam 4a | Exam 4b | Exam 5 | Exam 6 | Exam 7 |
| | of Component | PMSI_1_ | PMSI_1_ | PMSI_2_ | PMSI_2_ | PMSI_2_ | PMSI_2_ | PMSI_2_ |
| Chemical items | Function ( [symbol] ) | 115_1 | 144_1 | 64_1 | 80_2 | 59_1 | 87_ [symbol] | 89_1 |
| Tap Water | Solvent | | 49.03 | | | 50 | | |
| Crystal Plus 70 | Lubrication and | 8.493 | 3.758 | 8.872 | 4.021 | 3.758 | 4.289 | |
| T [symbol] Mineral Oil | nonpolar | | | | | | | |
| | chemicals | | | | | | | |
| Polysorb [symbol] | Emulsifier for | 1.301 | 0.576 | 0.973 | 0.402 | 0.576 | 0.657 | |
| 60 MSNF | encapsulation | | | | | | | |
| PEG100 Glyceryl | Emulsifier for | 0.076 | 0.034 | | | 0.034 | 0.038 | |
| Stearate | encapsulation | | | | | | | |
| Soy Protein | Porous | | | | | | 0.505 | |
| Isolate | microparticles | | | | | | | |
| | for coating | | | | | | | |
| | surface textures | | | | | | | |
| Candle Wax | Microparticles | 0. [symbol] 99 | 0.442 | 0.973 | 0.268 | 0.442 | | |
| | for slippery | | | | | | | |
| | coating surface | | | | | | | |
| | texture generation | | | | | | | |
| ZFT [symbol] 10 | Hydrogel | 0.5 | | | | | | |
| | Polymer | | | | | | | |
| ZFT [symbol] 20 | Hydrogel | | | 0.453 | 1.340 | 0.221 | 0.253 | |
| | polymer | | | | | | | |
| LX 641 | Liquid HPMA | | | | | | | |
| | (35.0%) | | | | | | | |
| LB 206 | HPAM in 35% | | 0.2105 | | | | | |
| | Concentration | | | | | | | |
| Sweet Rice Flour | Crosslinking | | | | | 0.221 | | |
| | agent | | | | | | | |
| Acrylate Urethane | Crosslinking | | | | 0.134 | | | |
| binder | agent | | | | | | | |
| NaCl | Mono [symbol] | | | | | | | 0.235 |
| | electrolyte | | | | | | | |
| CaCl₂ | Cationic | | | | | | | 4.23 |
| | Electrolyte | | | | | | | |
| KCl | mono [symbol] | | | | | | | 0.235 |
| | electrolyte (Clay | | | | | | | |
| | stabilizer) | | | | | | | |
| Tap Water | Solvent | 88.631 | 45.95 | 88.729 | 93.83 | 44.748 | [symbol] 4.26 | 95.3 |
| | Sub Total (wt. %) | 100 | 100.00 | 100 | 100.0 | 100 | 100.00 | 100 |
| | Key Ingredient | 11.37 | 5.02 | 11.27 | 6.17 | 5.25 | 5.74 | 4.70 |
| | Wt. % | | | | | | | |
| | Solids % | 2.88 | 1.13 | 2.40 | 2.06 | 1.49 | 1.45 | 4.7 |

[symbol]

indicates data missing or illegible when filed

Example 8: A measurement of rheological property was conducted with USS-DVT4 Viscometer that can test viscosity from 1 to 100,000 (cP) at rotary spindle speed at 6, 12, 30, and 60 (RPM) for each rotary rod (4 rods). The measured viscosities of example 1 at a dose level of friction reducer (HPAM: LX641) of 0.20% and 2.0% NaCl solution are listed in table 2. In addition, the total dissolved solids (TDS), electrical conductivity, temperature of tested sample and pH value of the tested sample are also listed in table 2.
Example 9: To a 250 (mL) of beaker, 250 (mL) solution sample from example 1 was charged and stirred. then, 12.5 (gram) of the sample from exam. 3f (PMSI_1_115_1) was added into the beaker slowly while the standard FR solution (example 1) was stirred around by a magnetic bar, then, viscosity of the solution was measured. The targeted dose of PMSI_1_115_1 was 5.0% of the total solution. The tested results are listed in table 2. The sample ID for this condition is labelled as PMSI_2_89_2.
Example 10: The blended solution from example 9 was charged to another 400 (mL) of beaker, then, 26.25 (g) brine solution from the example 7 was added into the spinning solution slowly to determine how the brine solution would affect the rheological property of FR solution. The sample ID for this condition is labelled as PMSI_2_90_1. The measured viscosity of the solution is also listed in table 2.
Example 11: To a 250 (mL) of beaker, 262.9 (g) of FR solution from example 1 was charged into the beaker. A magnetic bar was used to stir the solution, then, 26.29 (gram) of a coated proppant was added into the solution and blended for 5 (minutes), then, the solution was decanted from the beaker, subjected to the measurement of blended solution viscosity. The results of viscosity measurements are listed in table 2. The procedure for the coated hydrogel coating is comprising of charging 1000 (gram) of playground local sand into a Hamilton Beach Hobert mixer, then, adding 30.63 (gram) of example 4b formulation coatings into the Hobart mixer and mixing for another 3-5 (minutes). The mixed components were dried at an ambient temperature overnight, then, sealed, and packed into a plastic zip bag for late use. The sample ID was labelled as PMSI_2_90_2.
Example 12: To a 250 (mL) of beaker, 250.0 (gram) of FR solution from example 1 was charged into the beaker, then, 25.0 (gram) of special coating coated on the proppants having notebook ID of PMSI_2_81_2 was charged and blended in the beaker for 3 minutes with a magnetic stir bar, then, 25.0 (gram) of brine solution from example 7 (PMSI_2_89_1) was charged slowly into the beaker. After 5 minutes, the solution was decanted into another container. The viscosity of the solution was measured and are listed in the table 2. The sample ID is labelled as PMSI_2_91_2.
Example 13: To a 600 (mL) of beaker, 400.0 (gram) of FR solution from example 1 was charged into the beaker, then, 40.0 (gram) of brine solution of PMSI_2-89-1 charged and blended in the beaker for 3 minutes with a magnetic stir bar, then, 60.0 (gram) of emulsion coatings from the recipe of PMSI_1_115_1 were charged slowly into the beaker while stirring. After 5 minutes, the solution was decanted into another container. The viscosity of the solution was measured. The sample ID was labelled as PMSI_2_113_5. The obtained data is listed in the table 2.

The test results of rheology and solution properties based upon examples 8 to 13 are summarized in table 2. It was discovered that an incorporation of the disclosed recipes listed in examples 3 to 6 could potentially boost the hydrated viscosity of the standard fracturing fluid solution while maintain other performance properties of the products as the same. Also, in the case of the fracturing fluid containing large TDS of hard water with cationic ions such as Ca⁺² and Mg⁺², the added emulsion coatings could still maintain the hydrated viscosity of the fracking fluid.

TABLE 2
Assessment of the Influence of Brine Solution on Rheology and Solution Property
(TDS, EC, Temperature, pH value) for Examples 8 to 13

| | Description | | | | | |
|---|---|---|---|---|---|---|
| | | Example 9 | Example 10 | Example 11 | Example 12 | Example 13 |
| | | NB_ID: | NB_ID: | NB_ID: | NB_ID: | NB_ID: |
| | | PMSI_2_89_2 | PMSI_2_90_1 | PMSI_2_90_2 | PMSI_2_91_1 | PMSI 2_113_5 |
| | Example 8 | Std. FR Solution (PMSI_2_54_1) (M [symbol] ) | | | | |
| | NB_ID: | | 5.0% | | PMSI_2_81_2 | 10.0% |
| | PMSI 2_54_1 | 5.0% | PMSI_1_115 1 | 10.0% | ( [symbol] CP) | PMSI_2_89_1 |
| | LX641 @0.20% | PMSI_1_115_1 | 10.0% | PMSI_2_89_1 | 10.0% | 15% |
| | NaCl @ 2.05 | NA | PMSI_2_89_1 | NA | PMSI_2_89_1 | PMSI_1_115_1 |
| RPM | Viscosity (cP) with No1 Spindle | | | | | |
| 6 | 36 | 29 | 23 | 15 | 17 | 40 |
| 12 | 29 | 28 | 20 | 14.5 | 13.5 | 43.5 |
| 30 | 13.6 | 16 | 10.8 | 8.8 | 8 | 16.8 |
| 60 | 10.6 | 12 | 6.6 | 5 | 5 | 8.5 |
| Total Dissoved Solids (TDS) (ppm) | 2991 | | | | | 2840 |
| Electrical Conductivity (EC) (μs/cm) | 5983 | | | | | 5581 |
| Temperature (° C.): | 25.0 | | | | | 25.5 |
| PH value: | 7.86 | | | | | 7.54 |

Note:
Example 8 is defined as the Std. FR solution
PMSI_2_89_1: TDS water containing 4.7% (90% CaCl₂ + 5.0% KCl + 5.0% NaCl) mixed together [symbol]
indicates data missing or illegible when filed

As listed in table 2, the Brookfield viscosity of example 9 showed a 20% increase at a rod spindle rotary speed of 60 (RPM) over that of example 8 of the standard fracturing fluid solution. The shear rate at the rod spindle rotary speed of 60 (RPM) is equivalent to 1020 (1/s) shear rate, which is attributed to the added 5.0% emulsion coating prepared with the recipe of PMSI_1_115_1 recipe listed in table 1. Also, at the shear rate of 525 (1/s), the viscosity of example 9 was 16 (cps). In contrast, the viscosity of example 8 is only 13.6 (cps).

One well-known issue with regular fracturing fluid solution is that high concentration brine is detrimental to the fracturing fluid performance as illustrated in example 11, in which 10% of cationic solutions of PMSI_2_89_1 with calcium and magnesium cationic ions blended with standard fracturing fluid solution of example 1 reduced the mixed solution viscosity to 5.0 (cps) at the rod spindle rotary speed of 60 (RPM). The data result listed in example 10 demonstrates that a 5.0% addition of emulsion coatings with recipe of example 3f (table 1) into the standard FR solution increased its viscosity from 5.0 (cps) to 6.6 (cps) at the rod spindle rotation speed of 60 (RPM), 30% more than the viscosity in example 11.

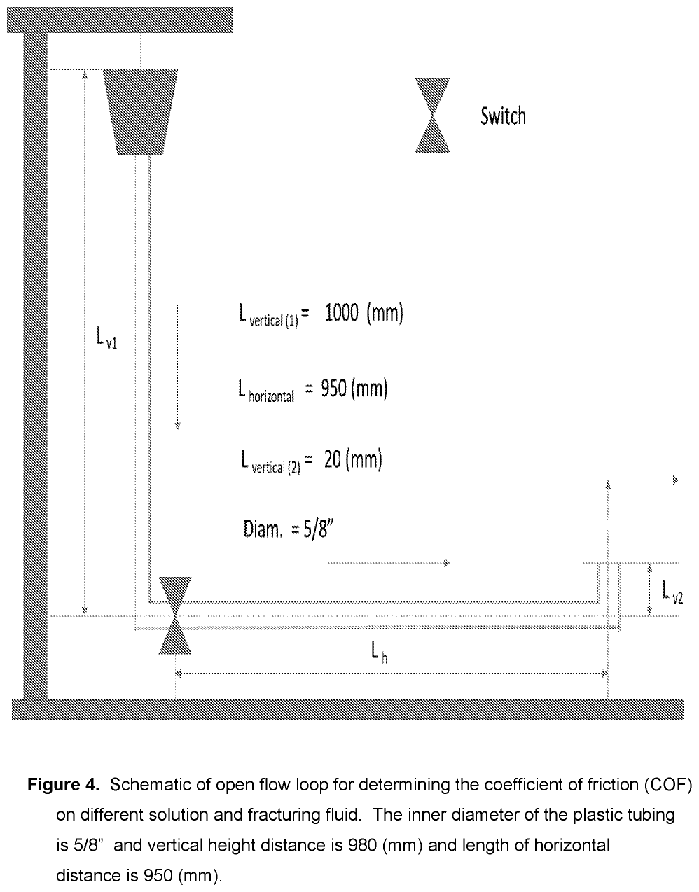

An increase of dose level incorporated the example 3f coatings at 15.0% will increase the hydrated viscosity of mixed fracturing fluid solution by 70.0% from 5.0 (cps) to 8.5 (cps) in example 11. In the example 12, 10% of emulsion coated proppants (PMSI_2_81_2) blended with the standard solution of example 8 for 3 minutes did not alter the viscosity of the example 11. Salt and cationic water tolerance will be enhanced if certain emulsion coatings are blended into the fracturing fluid.
Example 14: To a 250 (mL) of beaker, 260 (gram) of FR solution from example 1 was added into the beaker, then, 26.0 (gram) of playground proppants coated with disclosed coating recipes at a dose level of 3.0% (example 11) was added into the beaker, then, magnetic stir bar was used to stir the mixed components in the beaker with a timer to determine the relationship of mixing time with the rheological properties of fracturing fluid by measuring the viscosity of the mixed component solutions. Table 3 lists the test results of the measured viscosity at different rotary speed at room temperature of 25° C. The sample ID was labelled as PMSI_2_56_1. The rheology data listed in table 4 is re-plotted in FIG. 4. Evidently, at a spindle rotation speed of 6 (RPM), the Brookfield viscosity had a dramatic drop if the blending time was less than 20 (min.), however, it stabilized after 20 (minutes). At 12, 30, and 60 (RPM), the viscosities of standard FR solution were stable, leading to the conclusion that the shearing and cut-off of the FR polymers were minimized in the surface coated proppants even less friction reducer was used.

TABLE 3
Measured Viscosity of Blended FR Solution with
Surface Treated Proppants (PMSI_2_17-1) (Example 14)

| Blending | Viscosity (NO1 Spindle) (cP) | | | | % of Within Range | | | |
|---|---|---|---|---|---|---|---|---|
| Time (minute) | RPM = 6 | RPM = 12 | RPM = 30 | RPM = 60 | RPM = 6 | RPM = 12 | RPM = 30 | RPM = 60 |
| 5 | 9 | 20 | 14 | 10 | 0.9 | 4 | 7.1 | 10 |
| 10 | 4 | 19 | 14 | 10.9 | 0.4 | 1.9 | 7.2 | 9.8 |
| 15 | 18 | 20 | 12 | 9 | 2.58 | 9.1 | 6.2 | 9.2 |
| 20 | 24 | 20 | 11 | 9 | 2.8 | 4.2 | 5.6 | 9 |
| 30 | 22 | 24 | 11.6 | 8.7 | 2.1 | 4.8 | 11.6 | 8.6 |
| 40 | 21 | 20 | 10.8 | 8 | 2.1 | 1 | 5.2 | 8.7 |

Note:
Notebook ID for the measurement is PMSI_2_56_1
10% of PMSI_1_17_1 was mixed in the fractuing fluid containing 2.0% NaCl and 0.20% friction reducer
PMSI_1_17_1 was prepared by mixing 100.0% playsand with 1.5% of coatings of PMSI_1_115_1

Example 15: A home-made fracturing fluid flow device that has a pressure head pending upon material's gravity was used to characterize the flow behavior of different types of fracturing fluid in the test device as a primary screening tool for developing the additives and coating's recipes. As shown in FIG. 4, the device is comprising of five key portions: 1) vertical tubing (Lᵥ); 2) horizontal tubing (Lₕ); 3) a valve that controls the start and end of the liquid flow through the tubes; 4) a container that holds enough liquid on the top of the test tube; 5) a container that can preserve the whole volume of liquid flowed through the liquid. The length of the PVC test pipe is 1000 (mm) in the vertical direction and 950 (mm) in the horizontal direction. Its inner diameter is ⅝″. A plastic drinking bottle (hold about 300 mL of water) was used as the top container to hold the testing fracturing fluid. At the bottom of the testing device, a 20×20×10 (cm) of PVC container was used as the fluid receiver.

About 220-235 (gram) (m) of tested liquid was used to fill up the top container connected to the vertical plastic pipeline (Lᵥ). Quantity of the liquid (Q) flowing through the tubing pipeline in the vertical direction was measured by collecting the total quantities of liquid in the container located in the bottom by the end of the test. The total interval, at which the whole liquid flowed through the whole length (Lₕ) of pipeline in the horizontal direction, was determined by a digital timer (t). The viscosity of the flow liquid was calculated by the following Poiseuille's equation (1):

$${μ}_{a} = \frac{π {r}^{4} Δ {P}_{m} mt}{8 {L}_{H} Q ( t )} - 0.149 \frac{ρ Q ( t )}{π {L}_{H} t} \qquad ( 1 )$$

Where μₐ is the apparent viscosity of the tested liquid; r is the radius of the testing tube; ΔPₘ is the hydraulic pressure of the tested liquid, which can be calculated by subsequent equation (2); m is the total mass of tested liquid; t the total time for the liquid flowing through the whole pipeline in vertical direction; Q(t) is the total liquid through the pipeline in volume; g is the gravity; Lₕ is the pipeline length in the horizontal direction.

ΔPₘ=Hᵥρg (2)

where Lᵥ is the height of vertical testing tube; ρ is the density of the tested liquid.

The velocity (v) of liquid through testing tube was calculated with equation (3):

$$v = \frac{Q ( t )}{π {r}^{2} t} \qquad ( 3 )$$

The Reynolds number was calculated with equation (4):

$$Re = \frac{2 rv ρ}{{μ}_{a}} \qquad ( 4 )$$

Special fracturing fluid empirical formula was used to calculate the coefficient of friction (COF) for calculating the pressure difference (ΔP). Here, a Morrison correction factor was used to determine the COF as described in equation (5) (Assefa & Kansha, 2015):

$${C}_{f} = \frac{0.0076 {( \frac{3170}{{R}_{e}} )}^{0.165}}{1 + {( \frac{3170}{{R}_{e}} )}^{7.}} + \frac{16}{{R}_{e}} \qquad ( 5 )$$

Pressure difference in the test tubing could be calculated as described in equation (6), once Cf was obtained.

$$Δ P = ρ \frac{{L}_{h}}{4 rg} {C}_{f} {v}^{2} \qquad ( 6 )$$

The drag reduction (DR) percentage was calculated using equation (7):

$$( \% ) DR = \frac{Δ {P}_{ctrl .} - Δ {P}_{Drag}}{Δ {P}_{Ctrl .}} \qquad ( 7 )$$

It was assumed that the Reynolds number for tap water and others was 15000 (turbulent flow), the calculated dynamic viscosity was 0.00052 (mPa·s). The velocity of tap water through the test tube was 0.491 (m/s), ΔP (tap water)=203 (pascal). The calculated test results are listed in table 4.
Example 16: Total of 500 (gram) or so of PMSI_2_54_1 standard liquid solution (2.0% sodium chloride and 0.20% of FTZ610 HPAM friction reducer in the solution) was charged in the flow test device shown in FIG. 4. The total volume (Q(t)) of the tested liquid was 226.4 (mL) and time (t) 8.58 (second); calculated pressure difference (ΔP) 343 (Pascal).
Example 17: Total of 250 (gram) of standard FR solution of PMSI_2_54_1 was charged into a 250 (mL) of beaker, then, 12.5 (gram) PMSI_2_115_1 slippery liquid coating was blended with PMSI_2_54_1 standard FR frac fluid; then, the total volume (Q(t)) of the tested liquid was 238 (mL) and time (t) 6.31 (second); calculated pressure difference (ΔP) 188 (Pascal).
Example 18: Total of 250 (gram) of standard FR solution of PMSI_2_54_1 was charged into a 250 (mL) of beaker, then, 25.0 (gram) of hydrogel coating coated proppant (PMSI_2_81_2) at a dose level of 3.0% was blended into the FR solution. The time for the mixed frac fluid through the test tube was 6.27 (second). The calculated pressure difference (ΔP) 181 (Pascal).
Example 19: Total of 250 (gram) of tap water was charged into a 250 (mL) of beaker, then, 25.0 (gram) of uncoated playground sand was blended into the FR solution, then, 25 (gram) of PMSI_2_89_1 (brine solution) was charged into the beaker. The time for the mixed frac fluid through the test tube was 7.32 (second). Total volume of frac fluid was 238 (mL). The calculated pressure difference (ΔP) 247 (Pascal).
Example 20: Total of 250 (gram) of standard FR solution of PMSI_2_54_1 was charged into a 250 (mL) of beaker, then, 25.0 (gram) of PMSI_2_89_2, a hydrogel coated proppant was added into the beaker. After 10 Minutes, 25.0 (gram) of brine solution (containing 4.7% CalCl₂/KCl/KCl) was blended into the stirred solution. After 10 (minutes), the solution was decanted and separated from the coated proppants. The time for the mixed frac fluid through the test tube was 4.95 (second). Total volume of frac fluid was 234.0 (mL). The calculated pressure difference (ΔP) 114 (Pascal).
Example 21: Total of 250 (gram) of the tap water was added into a 250 (mL) of stirred beaker, then, 25.0 (gram) of hydrogel coating coated proppant (PMSI_2_81_2) at a dose level of 3.0% was blended into the tap water solution. After 10 Minutes, 25 (gram) of PMSI_2_89_1 brine solution was added into the beaker and continuously blended for another 10 (minutes), then, the solution was decanted and separated from the resin coated proppants. The time for the mixed frac fluid through the test tube was 7.13 (second). The calculated pressure difference (ΔP) 237 (Pascal).
Example 22: To a 250 (mL) beaker, 25.0% of hydrogel coating coated proppant (PMSI_2_81_2) at a dose level of 3.0% was charged into the beaker, then, 25 (gram) of brine solution of PMSI_2_89_2) was added into the beaker, blended with PMSI_2_81_2 for 5 (minutes), then, 250 (gram) of Standard FR solution of PMSI_2_54_1 was added to mix for another 10 (minutes) before being decanted to make measurement on frac fluid liquid behavior. The time for the frac fluid through the test tube was 7.46 (second) and calculated pressure difference (ΔP) 257 (pascal).
Example 23: To a 250 (mL) beaker, 250.0 (gram) of standard FR solution of PMSI_2_54_1 was added to the beaker. 25.0% of regular playground sand was charged into the beaker, then, blend of the above two components for at least 10 (minutes) before running other tests, then, 25 (gram) of brine solution of PMSI_2_89_2 was added into the beaker and blended for another 10 (minutes) before being decanted to make measurement on frac fluid liquid behavior. The time for the frac fluid through the test tube was 9.45 (second) and calculated pressure difference (ΔP) 406 (pascal).

TABLE 4
Calculated Friction Reduction Friction Drag Redction % Data with Selected Sample Condition (examples 15 to 23)

| | | | Time (t) | Velocity (m/s) | Calc PD(ΔP) | DR (%) |
|---|---|---|---|---|---|---|
| RUN ID | Examples | Description | (Sec) | @RE = 15000 | Pascal | (%) |
| 1 | Exam 15 | Tap Water (Ctrl.) | 6.6 | 0.491 | 203 | 50 |
| 2 | Exam 16 | NaCl @2.0% Plus 0.20% FR (LX641) Solution | 8.6 | 0.639 | 343 | 16 |
| 3 | Exam 17 | NaCl @2.0% + 0.20% FR(Lx641) + 5.0% PMSI_1_115_1 (SC) + | 6.3 | 0.470 | 188 | 54 |
| | | 10.0% PMSI_2_89_1 (Ca++) Solution only | | | | |
| 4 | Exam 18 | NaCl @2.0% + 0.20% FR(Lx641) + 1/10 PMSI_2_81_1(Coated Proppant) | 6.3 | 0.466 | 181 | 55 |
| | | without a hard water involved | | | | |
| 5 | Exam 19 | Tap Water + 1/10 uncoated Sand + 1/10 (PMSI_2_89_1) | 7.3 | 0.544 | 247 | 39 |
| | | (4.7% CaCl₂/KCl/NaCl solution) | | | | |
| 6 | Exam 20 | NaCl @2.0% + 0.20% FR(Lx641) + 1/10 PMSI_2_81_1 | 5.0 | 0.368 | 114 | 72 |
| | | (Coated Proppant) + 1/10 PMSI_2_89_1 (4.7% CaCl2/KCl/NaCl) | | | | |
| 7 | Exam 21 | Tap Water + 1/10 PMSI_2_81_1 (Coated Proppant) + | 7.1 | 0.531 | 237 | 42 |
| | | 1/10 (PMSI_2_89_1) (4.7% CaCl2/KCl/NaCl solution) | | | | |
| 8 | Exam 22 | 1/10 PMSI_2_81_1(Coated Proppant) + 1/10 PMSI_2_89_1 | 7.5 | 0.555 | 257 | 37 |
| | | (4.7% CaCl2/KCl/NaCl) + NaCl 2.0% + 0.20% FR(Lx461) Solution | | | | |
| 9 | Exam 23 | NaCl @2.0% + 0.20% FR(Lx641) Solution + 10% Uncoated Sand + | 9.4 | 0.703 | 406 | 0 |
| | | 10.0% PMSI_2_89_1 (4.7% CaCl2/KCl/NaCl) − Ctrl. | | | | |

A comparative study on exam 15 vs. exam 16 as listed in table 4 shows that more pumping pressure is needed if 2.0% NaCl and 0.20% friction reducer (FR) are used in exam 16 than in exam 15. Both chemical additives and samples coated with multi-functional coatings will significantly reduce the drag force (pumping pressure) significantly. For instance, a 5.0% addition of chemical composition of the sample in exam 17 and a blend of 1/10 addition of proppant coated with multifunctional coatings of the sample in exam. 18 could reduce the pumping pressure of DR % 45.8% and 47.2% over the sample in exam 16, based upon equation (7). The DR % of these two samples in exam 17 and 18 are 54% and 55% less than exam. 23 (Ctrl.).

All the data in the examples from 15 to 23 is summarized in the table 4. Of the tested samples from examples 15 to 23, if the proppant is coated with PMSI_81_1 at a dose level of 1.5% (example 20), its drag reduction % will reduce by 72% over the control condition of the untreated sands at a NaCl 2.0% and friction reducer of 0.20% fracturing fluid solution (example 23). Clearly, the DR % originally from multifunctional coatings are exceptional in exam 20 over the exam 23 even in case that there are a lot of cationic ions containing in the solution.

Sine less drag force is needed in the coated frac sand, an application of the disclosed coatings will use less pumping energy to drive the proppants down further under the downhole condition. The tool and equipment wear-out cost could also potentially be reduced due to the reduced friction of coatings. Besides a comparison between example 20 and 23, drag-force reductions, to certain degree, are also demonstrated in other samples.
Example 24: To a Hamilton Beach Mixer, 1000 (gram) of playground sand (local sand) was charged into the mixer's bowl, then, 15.0 (gram) of FTZ610 of HPAM in powder was added into the mixer. The added components were stirred slightly, then, 9 (gram) of tap water was added into the mixer, continuously blended for another 5 (min.) before being packed in the plastic zip bag for late use.

The swelling percentage of the above samples was measured following the procedures described here. 1) pre-dry the sample in the oven-overnight, then; charge the sample with a reusable home-made cloth container to hold 50.0 (gram) of samples in each bag; 2) determine the bag's original weight and after being pre-soaked weight with a digital balance prior to packing the 50 (gram) of the tested sample; 3) immerse the samples with tap water at the ambient temperature and 4) start to count the time; and take the samples weight at a regular time interval among 1, 2, 3, 5, 10, 20, 30 (minutes), then, place the soaked sample back to the same bathes. The percentage of mass swelling was determined by equation (8):

$$\% Swelling = \frac{M - {M}_{0}}{{M}_{0}} \times 100 \qquad ( 8 )$$

where M is the weight of samples at time (t); Mo is the weight of samples before being immersed in the tested solvent/water.

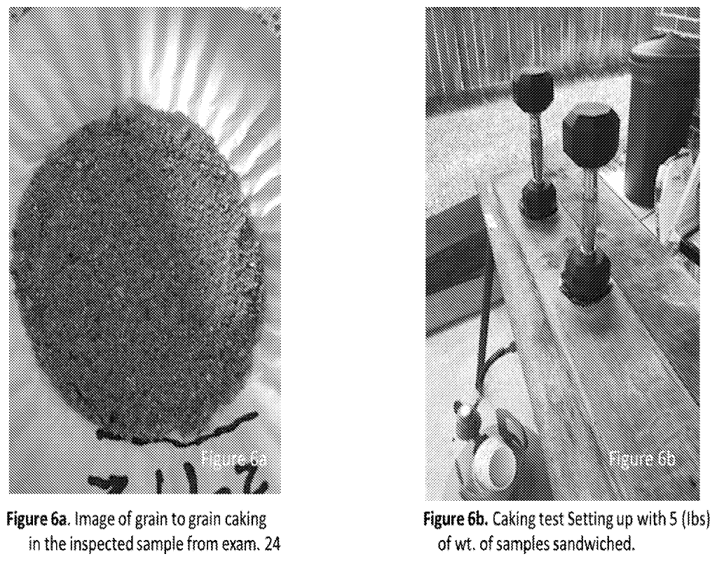

The % swelling following the above procedure for example 24 is listed in table 5. The average % Swelling rate=43.47% after being immersed in water for 300 (second); 46.00% after 600 (second). All experimental data reported is an average value of 3 individual measurements of samples. A caking phenomenon was observed after the wet sample was dried under the sun with a 5 (lbs) of weight placed on the top of the sandwiched aluminum foils on the inspected sample from the example 24 as shown in FIG. 6a.
Example 25: To a Hamilton Beach Mixer, 1000 (gram) of playground sand (local sand) was charged into the mixer's bowl, then, 15.0 (gram) of disclosed coating prepared with example 3 g (PMSI_1_144_1) was added into the mixer and blended for about two to three minutes, then, 11.5 (gram) of FTZ610 of HPAM in powder was added into the mixer, and the added HPAM in powder was stirred for two to three minutes, then, 15.0 (gram) of coating labeled PMSI_1_144_1 was added into the mixer, continuously blended for another 5 (minutes) before being packed in the plastic zip bag for late use. No caking or sticky issue was observed in the final coatings. The % swelling rate=33.78(%) after the samples were immersed in Di-water at 300 (second) and 33.65% at 600 (second). The measured results are listed in table 5.

Following the same procedures as example 24 of setting up the caking and blocking test, 50.0 (gam) of coated samples from example 25 were soaked with tap water and sandwiched between two sheet of aluminum foils, then, 5 (lbs) of weight on the aluminum foil was placed on the samples sandwiched between two aluminum films. The samples were left at ambient temperature under outdoor environment under the sun in a parallel order as example 24. After the samples were exposed under the sun more than 72 hours with the 5 (lbs) of weights, the samples from both examples of 24 and 25 were inspected. No caking and blocking occurred in the example of 25. Individual grains could move independently from each other without caking and sticking together.

The applicants believe that the addition of the disclosed coating blended into the powder FR or liquid FR is a unique feature of this invented technologies from previous art and literature. The proppant grains coated with the disclosed coatings did not encounter the issues of grain to grain sticking together. It is conceivable that in the actual production, there is no need to dry the products when the coating is mixed or blended with FR chemical additives in both liquid and powder form. The products can be transported and handled without an issue of arching and bridging from manufacturing plant to terminal, from the onsite oil field to the downhole bottom well-bore, and from bottom wellbore to target destination of fracturing crack of the formation. Experimental test setting on the two samples from example 24 and 25 is shown in FIG. 6b.
Example 26: To a Hamilton Beach Mixer, 1000 (gram) of playground sand (local sand) was charged into the mixer's bowl, then, 11.5 (gram) of FTZ610 of HPAM in powder was added into the mixer, and the added HPAM in powder was stirred and blended for two to three minutes, then, 15.0 (gram) of disclosed coating of PMSI_1_144_1 was added into the mixer, continuously blended for another 5 (minutes) before being packed in the plastic zip bag for late use. No caking or sticky issue was observed in the final coatings without a drying operation. The % swelling rate of the sample=33.73% after 300 (second); 40.81% after being immersed for 600 (second).
Example 27: To a Hamilton Beach Mixer, 1000 (gram) of playground sand (local sand) was charged into the mixer's bowl, then, 30.0 (gram) of slippery coatings of PMSI_1_144_1 were added into the mixer, continuously blended for another 5 (minutes) before being packed in the plastic zip bag for late use, then, the sample was tested with swelling rate test standard following example 24 procedure. No caking issue was observed without a drying operation in the final coatings. The % swelling rate=16.80(%) after being immersed in di-water for 300 (second). No sticking issue was observed after the sample was dried under the sun.
Example 28: 50 (gram) of playground sand (local sand) was charged into sample hold container. The % swelling rates of the tested samples was determined following the procedures described in example 24. No sticky issue was observed without a drying operation. The % swelling rate=16.80(%) after being immersed in the di-water for 300 (second). Table 5 summarizes the measured % swelling rate for the examples of samples from 24 to 28.

In addition, samples from exam 25 and 26 might be potential candidates for preventing the excessive leak-off of processing water after the wells are closed since both are swollen extensively that can hold processing water from flowing.

TABLE 5
Measuered Swelling Percentage of Selected Test Samples and
Inspection of Caking and Blocking Test (Examples 24 to 28)

| | | Swelling Test | |
|---|---|---|---|
| | | Wt. % in Tap Water | Caking and Blocking |
| | | Soaking Time | Test Observation |
| Sample ID | Sample Description | 5 (Minutes) | Yes/No |
| Example 24 | PMSI_2_18_4:1.5% FTZ610/0.9% Water | 43.47 | Y |
| Example 25 | PMSI_2_19_1:1.15% FTZ610/1.5% × 2(PMSI_1-144-1) | 33.78 | N |
| Example 26 | PMSI_2_19_2:1.15% FTZ610/1.5% (PMSI_1-144-1) | 33.73 | N |
| Example 27 | PMSI_2_19_3:3.0% PMSI_1_144_1 Only | 16.8 | N |
| Example 28 | Sakarete:Playground local brown sand | 15.1 | N |

Example 29: To a 250 (mL) of beaker, 250 (gram) of tap water was added into the beaker, and 25.0 (gram) of the sample from Example 24 was charged while the added water was stirred with a magnetic stir bar. After the mixed components were blended for about 40 (minutes), the solution was decanted into another plastic cup and separated from the coated sand components. The viscosity of the decanted solution was determined by Brookfield viscosity meter (spindle No 1) at rotary speed rate (RSR) of 6, 12, 30, and 60 (RPM). Three individual measurements were conducted with the solution at an ambient temperature of 25.0° C. The viscosity of the example 29 at the RPR of 6 (RPM) is equivalent to 50.7 (cP); 12 (RPM) 40 (cP); 30 (RPM) 22.5 (cP); 60 (RPM) 18.2 (cP). The total dissolved solids (TDS) of the solution was 755 (ppm); electrical conductivity (EC) was 1500 (μs/cm); the pH value was 7.67. In addition, the solution of the sample was also decanted at the following interval of 15 (minutes), 20 (minutes), 30 (minutes), 40 (minutes). Its viscosities were also determined. All measured viscosities of the tested samples are listed in table 6 for the sample of exam. 29.
Example 30: To a 250 (mL) of beaker, 250 (gram) of tap water was added into the beaker, and 25.0 (gram) of the sample from Exam. 25 (PMSI_2_19_1) was charged while the added water was stirred with a magnetic stir bar. After the mixed components were blended for about 40 (second), the blended components were stirred in the beaker uniformly with good vertex. After 5 (minutes), the solution was decanted into another plastic cup and separated from the coated sand components. The viscosity of the decanted solution was determined by Brookfield viscosity meter (spindle No 1) at rotary speed rate (RSR) of 6, 12, 30, and 60 (RPM) at an ambient temperature of 25.0° C. The measured viscosity of the exam. 30 at the RPR of 6 (RPM) was equivalent to 20 (cP); 12 (RPM) 34 (cP); 30 (RPM) 19.0 (cP); 60 (RPM) 12.2 (cP) after the mixed components stirred in the beaker at the measured time of 5 (minutes), then, at 10 (minutes), 6 (RPM) 8.0 (cP); 12 (RPM) 27.0 (cP); 30 (RPM) 18.0; 60 (RPM) 11.0 (cP). In addition, the solution of the sample was also decanted at the following interval of 15 (minutes), 20 (minutes), 30 (minutes), 40 (minutes). Their viscosities were determined.
Example 31: To a 250 (mL) of beaker, 250 (gram) of Standard friction reducer solution (2.0% Sodium chloride+0.20% friction reducer) was added into the beaker, and 25.0 (gram) of the sample from Example 27 (PMSI_2_19_3) was charged while the added water was stirred with a magnetic stir bar. After the mixed components were blended for about 40 (second), the blended components were stirred in the beaker uniformly with a vertex. After 5 (minutes), the solution was decanted into another plastic cup and separated from the coated sand components. The viscosity of the decanted solution was determined by Brookfield viscosity meter (spindle No 1) at rotary speed rate (RSR) of 6, 12, 30, and 60 (RPM) at an ambient temperature of 25.0° C. The measured viscosity of the example 31 at the RPR of 6 (RPM) was equivalent to 33 (cP); 12 (RPM) 34 (cP); 30 (RPM) 17.0 (cP); 60 (RPM) 12 (cP) after the mixed components stirred in the beaker at the measured time of 5 (minutes), then, at 10 (minutes), 6 (RPM) 33 (cP); 12 (RPM) 32 (cP); 30 (RPM) 16.8; 60 (RPM) 11.7 (cP). In addition, the solution of the sample was also decanted at the following interval of 15 (minutes), 20 (minutes), 30 (minutes), 40 (minutes). Its viscosities were also determined. In addition, the solution of the sample was also decanted at the following interval of 15 (minutes), 20 (minutes), 30 (minutes), 40 (minutes). Its viscosities were also determined.
Example 32: To a 250 (mL) of beaker, 250 (gram) of Standard friction reducer solution (2.0% Sodium chloride+0.20% friction reducer) was added into the beaker, and 25.0 (gram) of the sample from a local playground sand was charged while the added water was stirred with a magnetic stir bar. After the mixed components were blended for about 40 (second), the blended components were stirred in the beaker uniformly with a vertex. After 5 (minutes), the solution was decanted into another plastic cup and separated from the coated sand components. The viscosity of the decanted solution was determined by Brookfield viscosity meter (spindle No 1) at rotary speed rate (RSR) of 6, 12, 30, and 60 (RPM) at an ambient temperature of 25.0° C. The measured viscosity of the example 31 at the RPR of 6 (RPM) is equivalent to 41 (cP); 12 (RPM) 33.5 (cP); 30 (RPM) 18.0 (cP); 60 (RPM) 12.9 (cP) after the mixed components stirred in the beaker at an interval of 5 (minutes). Then, at an interval of 10 (minutes), 6 (RPM) 36 (cP); 12 (RPM) 33.5 (cP); 30 (RPM) 16.6; 60 (RPM) 12.0 (cP). In addition, the solution of the sample was also decanted at the following interval of 15 (minutes), 20 (minutes), 30 (minutes), 40 (minutes). Its viscosities were also determined.

For a shear thinning materials such as described here, the rheological properties of the decanted solutions were described with Bingham's model with equation (9):

μ=k(y)ⁿ (9)

where r is the shear rate of tested solution; k consistency index; n fracturing fluid flow index in the Bingham model.

The Reynolds number used for characterizing the flow behavior were calculated with a more general equation shown in equation (10):

$${R}_{e} = \frac{{d}^{n} {v}^{2 - n} ρ}{{8}^{n - 1} k} {( \frac{4 n}{3 n + 1} )}^{n} \qquad ( 10 )$$

Based upon the equations (9) and (10), the Reynolds number for each tested solution was calculated and the efficient of friction (EOF) was calculated and plotted in FIG. 6.
Example 33: To a 250 (mL) of beaker, 260 (gram) of a friction reducer solution (0.15% concentration of FTZ610 in powder+2.0% NaCl) was added into the beaker, then, 2.6 (g) of PMSI_1_115_1 slippery solution was added into the beaker, then, 26.0 (gram) of the regular sand was charged while the added water was stirred with a magnetic stir bar. After the mixed components were blended for about 40 (second), the blended components were stirred in the beaker uniformly with a vertex. After 5 (minutes), the solution was decanted into another plastic cup and separated from the coated sand components. The viscosity of the decanted solution was determined by Brookfield viscosity meter (spindle No 1) at rotary speed rate (RSR) of 6, 12, 30, and 60 (RPM) at an ambient temperature of 25.0° C. The measured viscosity of the example 33 at the RPR of 6 (RPM) is equivalent to 45 (cP); 12 (RPM) 32.5 (cP); 30 (RPM) 20.0 (cP); 60 (RPM) 15 (cP) after the mixed components stirred in the beaker at the measured time of 5 (minutes). Then, at 10 (minutes), 6 (RPM) 32 (cP); 12 (RPM) 26.5 (cP); 30 (RPM) 14.0; 60 (RPM) 10.0 (cP). In addition, the solution of the sample was also decanted at the following interval of 15 (minutes), 20 (minutes), 30 (minutes), 40 (minutes). Their viscosities were also determined.

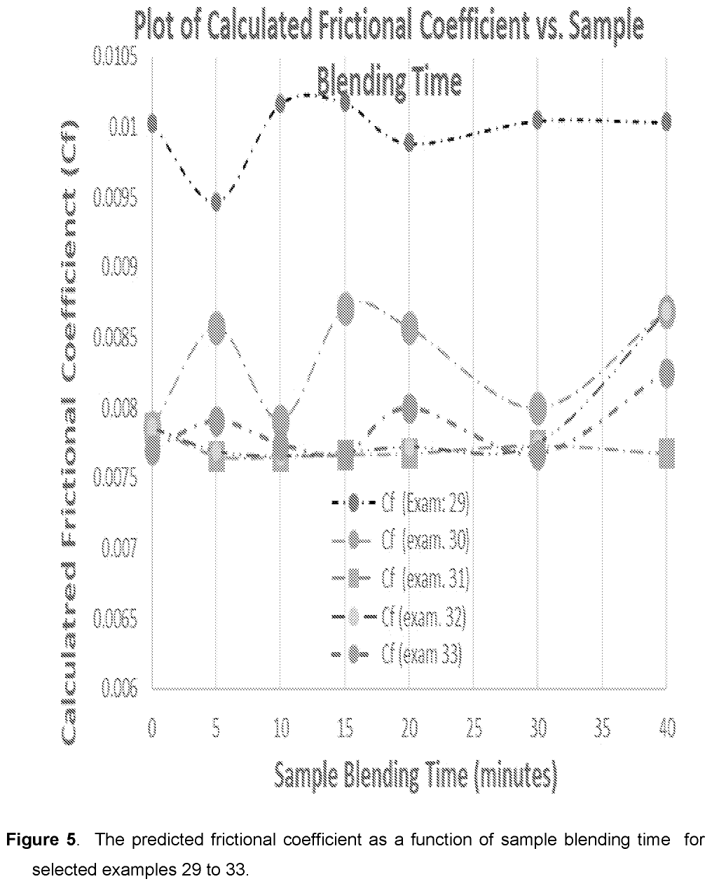

The rheological property data measured in examples 29 to 33 was fitted with equations 9 and 10 to obtain the Reynolds number, then, coefficient of friction in a response to the tested sample at specific blending time was calculated based upon the equation 5. A plot of frictional coefficient vs. sample's blending time is shown in FIG. 5. Clearly, the frictional coefficient or coefficient of friction (COF) in the example 29 was the highest of all the selected samples. With a dose of 1.5% of FTZ FR in powder coated on the surface of proppants, the polymer in fracturing fluid solution was expanded greatly with a swelling rate about 46.0% after 5 (minutes). Although the solution concentration was established very fast within the first 5 (minutes), the hydration of the coatings was continuously established within the whole blending time of 40 minutes. Shearing and degradation of coiled polymers potentially occurred during the period of blending and circulation. A high dose level of friction reducer chemicals is potentially required to eliminate the variation of pumping pressure spikes due to the high interaction of polymers with moving proppants.

In example 30, the friction coefficient of the tested sample has the similar cycle variation pattern as example 29 with a reduced value of frictional coefficient since the fracturing fluid used in this case was standard fracturing fluid instead of water. In addition, the added emulsion coatings made the coatings more slippery, protecting the fracturing fluid from further degradation and shearing loss.

In example 31, the friction coefficient was kept consistent during the whole blending period without a variation. In this case, the slippery coatings, in fact, blocked the proppants from strong interaction with standard fracturing fluid polymers. Potentially, less shearing and polymer degradation occurred during the blending and transportation of proppants into wellbore. Potentially, the dose of frac fluid (FR) can be reduced while keep the performance of mixed solution the same.

In example 32, the frictional coefficient of the decant solution presented consistent value around 0.0077-0.0078 until 30 (minutes). Shearing and cut-off of polymer molecules occurred more extensively after a blending time of 30 (minutes).
In example 33, a 1.0% addition of emulsion coating into a less concentrated fracturing fluid recipe seemed to provide a compromise solution of increasing the hydrated viscosity of the disclosed coatings in comparison with examples 31 and 32.
Example 34: 5 (gram) of local playground sand was charged into a home-made dust chamber. The dust concentration of the tested samples was monitored and recorded at a time interval of 30 (second) for 10 (minute), then, the dust concentration from the meter on PM2.5, PM1.0, and PM10 was used.
Example 35: 1000 (gram) of local playground sand was charged into a Hamilton Beach mixer, then, 30 (gram) of coatings, prepared by following the procedures of example 4b (PMSI_2_80_2), was charged into the mixer, then, the coated proppants were dried under the sun in an aluminum pan. 50 (gram) of the dried samples were charged into the Hamilton Beach mixer and dust concentration of the samples were monitored at an interval of 30 (second) for 10 (minutes) following the standard procedures of the testing samples.
Example 36: 1000 (gram) of local playground sand was charged into a Hamilton Beach Mixer, then, 30 (gram) of coatings, prepared by following the procedures of example 5 (notebook ID: PMSI_2_59_1), was added into the mixer, then, the two mixed components was blended for 5 minutes before being sealed in the plastic bag. The tested sample was dried under the sun, then, 50 (gram) of the sample was tested following a standard procedure to determine the dust concentration of the tested samples within 10 (minutes) in the sealed dust test chamber.
Example 37:1000 (gram) of local playground sand was charged into a Hamilton Beach Mixer, then, 30 (gram) of coatings, prepared by following the procedures of example 6 (notebook ID: PMSI_2_87_1), was added into the mixer, then, the two mixed components were blended for 5 minutes before being sealed in the plastic bag. The tested sample was dried under the sun, then, 50 (gram) of the sample was tested following a standard procedure to determine the dust concentration of the tested samples within 10 (minutes) in the sealed dust test chamber.
Example 38: 1000 (gram) of local playground sand was charged into a Hamilton Beach mixer, then, 1.0 (gram) of 70 T mineral oil was blended into the mixer (PMSI_1_112_1). The two mixed components were blended at least two minutes before sealed in the plastic bag for late use. 50 (gram) of the sample was collected to determine its dust concentration in the home-made dust test chamber. The relative % of dust concentration was calculated following a standard procedure and protocol.
Example 39: 1000 (gram) of local playground sand was charged into a Hamilton Beach Mixer, then, 15 (gram) of FTZ610 in powder (HPAM) was added into the mixer, then, 9 (gram) of tap water was added into the mixer with slow agitation, then, the three mixed components were blended for 5 minutes before being sealed in the plastic bag. The tested sample was dried under the sun, then, 50 (gram) of the sample was tested following a standard procedure to determine the dust concentration of the tested samples within 10 (minutes) in the sealed home-made dust chamber.

To get a better comparison, the dust concentration (D_{example 34}) from untreated sand (example 34) was used as base. The reduction % for other treated samples was calculated with the following equation 11.

$$Dust Reduction ( DR ) = \sum 100 \times \frac{{D}_{34} ( i ) - {D}_{x} ( i )}{{D}_{34}} \qquad ( 11 )$$

where % DR is the sum of % dust reduction, Dₓ(i) is the measured dust concentration at the time interval of i.

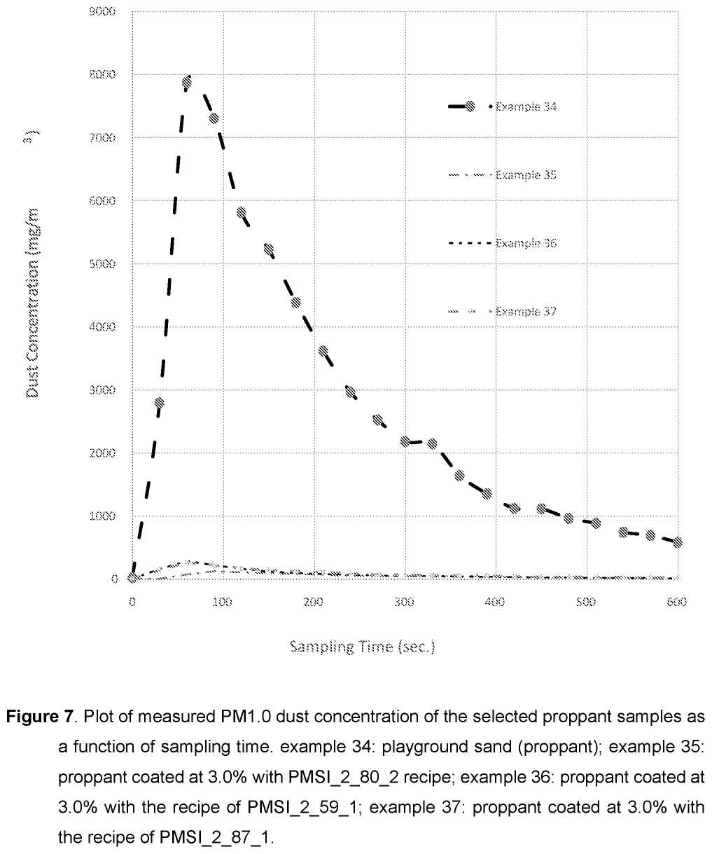

A comparison of dust concentration among the tested examples 34 to 39 is shown in FIG. 7. Evidently, the measured PM1.0 dust concentrations of examples 35, 36, 37, 38 were reduced significantly. Table 6 summarizes the relative dust percent reduction for the coated proppant samples calculated following the equation (11). Clearly, the dust concentration of surface treated proppants for example 35 was reduced more than 98(%). This result is excellent in term of reduction of dust concentration for the coated proppants in comparison with exam 39 sample of using 0.15% HPAM in powder at 93.28(%) and exam. 38 with 100% active ingredient of mineral oil at 86.90(%).

TABLE 6
Measured Dust % Reduction vs. Chemical Dose Level

| | | | | | | Dust % |
|---|---|---|---|---|---|---|
| | | | Solution | | | Reduction |
| RUN ID | Notebook ID | Sample Description | Conc. (%) | Dose (%) | Solids % | of PM1.0 |
| Exam. 34 | PMSI_2_19_3 | Sample Dried Under Sun (**) | 4.82 | 3 | 0.1446 | 98.5 |
| Exam. 35 | PMSI_2_19_4 | Sample Dried Under Sun (**) | 4.82 | 2.3 | 0.09936 | 90.4 |
| Exam. 36 | PMSI_2_81_2 | sample Dried under Sun (***) | 4.9164 | 2.3 | 0.113077 | 96.4 |
| Exam. 37 | PMSI_2_81_1 | Sample Dried under Sun (***) | 4.9164 | 3 | 0.147492 | 98 |
| Exam. 38 | PMSI_2_18_4 | FR_Powder @0.15% with water moistured | 0.15 | 1.5 | 0.15 | 93.28 |
| Exam. 39 | PMSI_1_112_1 | Mineral Oil | 100 | 0.1 | 0.1 | 86.9 |

Note:
(**) Regression of Dust % Reduction vs. Key Ingredient (%): DR (%) = 79.927 KI(%) + 84.832 (r2 = 0.9994)
(***) The samples were surface coated with a solution having concentration of 4.82% under the ambient condition in the same sunshine.

Example 40a: To a glass slide of 3.5″×3.5″, 2.70 (gram) of coating based upon PMSI_2_81_1 recipe was sprayed on it. The coating was left on a countertop at ambient temperature for curing and drying at least 24 hr. before being used, then, a drop of water was placed on the top of the coated glass slide with a needle of syringes. The weight of the droplet (wt.) was determined by measuring the weight of the syringe before and after the droplets were injected and placed on the coatings. The image of the droplet on the glass slide was recorded. The static contact angle of the microdroplets was determined by analyzing the photo image placed in the Microsoft PowerPoint, then, one end of the glass slide was lifted slowly to tilt the glass slide with a yard to measure the sliding angle (a) until the microdroplet started to roll down the coating surface suddenly. The maximum tilted angle that drives the microdroplet rotating down sides was recorded as its sliding angle (a).
Example 40b: The above procedure in Exam 40a was repeated within the same glass slide except that corn oil (a vegetable oil) was used to replace the tap water as probe liquid.
Example 40c: The above procedure in Exam 40a and 40b was repeated as example 40a except that the coating was replaced with a standard friction reducer solution of fracturing fluid as a coating spread on glass slides (example 1: PMSI_2_54-1).

It is well-known that for a lotus leaf observed under the scanning electronic microscopy (SEM) on the very distinctive surface of its tips, a hydrophilic second layer is formed by thin nanometric wires. This structure is covered with a waxy layer that increases the hydrophobic effect, which makes the water droplets maintain its spherical shape. The waxy layer favors the rolling of the droplets by forming a thin layer of air on the top of the waxy layer. Self-cleaning functionality is granted with the water microdroplet carrying the dust particles away from the lotus leaf.

Different from the lotus leaf, if the disclosed multi-functional coating is applied on the proppant surface, it tends to have hydrophobic domain's tips comprised of waxy or other hydrophobic particles directly protruded on the surface of the coatings surrounded with hydrogel polymers immersed in the mineral oil and/or lubricant domains. Since the thin film of mineral or hydrocarbon chemical compositions allows the water dispersed into the coating matrix easily, the water droplet tends to have better wetting capability toward the mineral oil. If the water droplet is small, it can pin self on the surface of coated materials instead of rolling down the surface of coatings. As a result, the drag-force or friction between the probe liquid and coating surface is very small. The consumption of energy for fracturing fluid or oil through the coated proppants is minimized.

Quantitatively, the contact angle of the coated coatings can be expressed with Cassie and Baxter equation (12).

Cos(θ_{Y})=f₁ cos(θ₁)+f₂ cos(θ₂) (12)

where θ_{Y} is the measured static contact angle of composite materials for a smooth surface, f₁ is the percentage of surface covered by component 1 such as wax; f₂ by component 2 such as lubricant or mineral oil or hydrogel coatings; θ₁ contact angle of wax under static condition; θ₂ the contact angle of lubricant and/or mineral oil/hydrogel polymer layer to the probe liquid.

Fundamentally, the measurement of contact angle and sliding angle is a complex research topic. Publications on how the measured contact angles are related with surface chemistry and topo-graphics of composite materials are widely available in the internet website and literature (Miwa, et al. 2000). Besides, static contact angle, advancing contact angle, and receding contact angles are measurable parameters for characterizing the microdroplets. The hysteresis of material's surface with different chemical composition and roughness is considered as a major reason that causes the variation of advancing and receding contact angles. The sliding angle (SA)−α can be correlated with the advancing contact angle (θ_{adv.}) and receding contact angle (θ_{red.}). Previous experiment demonstrates that the static contact angle (θ_{stat.}) on a smooth surface can be related with advancing contact angle as θ_{adv.}=θ_{stat.}+Δθ and receding θ_{rec.}=θ_{stat.}+Δ←. Here, Δθ is equivalent to (θ_{red.}−θ_{ads.})/2 and ΔG was calculated with equation 13

sin(Δθ)=a*sin(α)*sin(θ_{stat.})/{2−3 cos(θₛₜₐₜ)+cos(θₛₜₐₜ)³}^{1/3} (13)

where

$$a = \frac{mg}{2 σ} {( \frac{π g}{24 m} )}^{1 / 3} \qquad ( 14 )$$

m is the mass of microdroplet.
σ is the surface tension of probe liquid used for making the microdroplet.

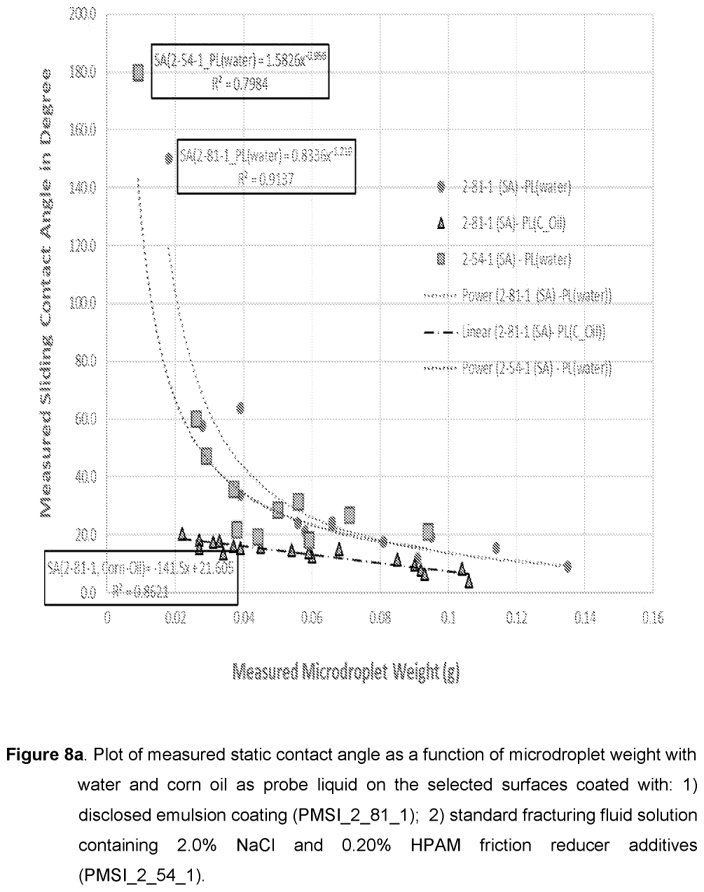

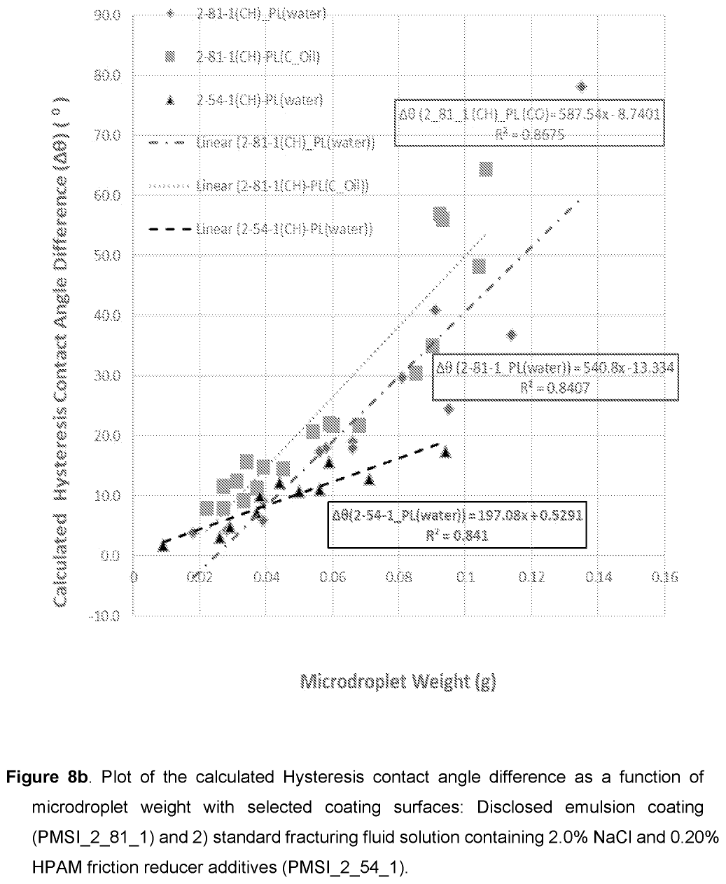

Table 7 lists the summary of measured sliding angle (α), static contact angle (θ_{stat.}), the hysteresis angle (Δθ) and microdroplet weight of the tested samples with selected coating surfaces. FIG. 8a plots the static contact angle of the measured microdroplets as a function of microdroplet weight with probe liquids of water and corn oil. FIG. 8b plots the contact angle hysteresis difference as a function of microdroplet weight. It is concluded that all the interface properties of microdroplet determined is a function of weight of microdroplets and its shape and sizes, subject to variation that controlled by their surface chemical composition and topographic morphologies.

TABLE 7
Summary of Measured Contact Sliding Angle (α) and Static Contact Angle (θ_{stat.}) and Calculated
Hysteresis Angle for Selected Coatings on the smooth Glass Slides

| | Notebook ID: PMSI_2_81_1 | | | | | | | | | | | |
|---|---|---|---|---|---|---|---|---|---|---|---|---|
| | Exam. 40a: Liquid Probe (LP): | | | | | | | | Notebook ID: PMSI_2_54_1 | | | |
| | Tap Water | | | | Exam. 40b: Liquid Probe: Corn Oil | | | | Exam. 40c: LP: Tap Water | | | |
| | | | Static | | | | Static | | | | Static | |
| | Micro- | Sliding | Contact | Cal. | Micro- | Sliding | Contact | Cal. | Micro- | Sliding | Contact | Cal. |
| Run | droplet | Angle | Angle | Hysteresis | droplet | Angle | Angle | Hysteresis | droplet | Angle | Angle | Hysteresis |
| ID | (g) | (°) | (°) | (Δθ) | (g) | (°) | (°) | (Δθ) | (g) | (°) | (°) | (Δθ) |
| 1 | 0.018 | 150.0 | 65.0 | 3.9 | 0.022 | 20.3 | 40.5 | 8.0 | 0.044 | 19.2 | 31.5 | 12.2 |
| 2 | 0.039 | 63.6 | 74.0 | 6.0 | 0.031 | 17.5 | 49.0 | 12.5 | 0.009 | 180 | 40 | 1.7 |
| 3 | 0.058 | 21.0 | 62.5 | 18.0 | 0.034 | 13.5 | 39.5 | 15.8 | 0.029 | 47.4 | 51 | 5.0 |
| 4 | 0.066 | 23.2 | 70.0 | 19.0 | 0.045 | 15.7 | 29.0 | 14.6 | 0.056 | 31.7 | 53.5 | 11.0 |
| 5 | 0.066 | 24.2 | 68.5 | 18.0 | 0.06 | 12.5 | 27.0 | 21.9 | 0.05 | 28.7 | 48.5 | 10.7 |
| 6 | 0.095 | 19.5 | 49.5 | 24.5 | 0.09 | 9.6 | 20.5 | 35.1 | 0.071 | 26.7 | 36 | 12.9 |
| 7 | 0.081 | 17.5 | 72.0 | 29.8 | 0.027 | 18.2 | 21.5 | 8.0 | 0.038 | 21.7 | 33.5 | 10.0 |
| 8 | 0.039 | 33.7 | 68.0 | 9.2 | 0.027 | 15.5 | 38.5 | 11.7 | 0.094 | 21 | 26 | 17.4 |
| 9 | 0.056 | 23.9 | 76.0 | 17.3 | 0.037 | 16.0 | 22.0 | 11.4 | 0.026 | 60.3 | 27.5 | 3.1 |
| 10 | 0.028 | 57.7 | 52.0 | 4.2 | 0.059 | 14.0 | 38.5 | 22.1 | 0.059 | 18.1 | 31 | 15.7 |
| 11 | 0.114 | 15.3 | 51.0 | 36.9 | 0.085 | 11.4 | 26.0 | 30.5 | 0.037 | 36 | 50 | 7.2 |
| 12 | 0.091 | 12.0 | 51.0 | 40.9 | 0.104 | 8.2 | 21.0 | 48.3 | NA | NA | NA | NA |
| 13 | 0.135 | 8.8 | 33.5 | 78.1 | 0.033 | 18.0 | 21.5 | 9.3 | NA | NA | NA | NA |
| 14 | NA | NA | NA | NA | 0.039 | 15.5 | 38.0 | 14.9 | NA | NA | NA | NA |
| 15 | NA | NA | NA | NA | 0.054 | 14.6 | 42.5 | 20.7 | NA | NA | NA | NA |
| 16 | NA | NA | NA | NA | 0.068 | 14.9 | 34.0 | 21.8 | NA | NA | NA | NA |
| 17 | NA | NA | NA | NA | 0.092 | 8.0 | 34.0 | 56.9 | NA | NA | NA | NA |
| 18 | NA | NA | NA | NA | 0.106 | 4.0 | 43.5 | 64.4 | NA | NA | NA | NA |
| 19 | NA | NA | NA | NA | 0.093 | 6.6 | 56.0 | 56.1 | NA | NA | NA | NA |

As the coated proppants are packed together in the downhole fracture and formation, the channels among adjacent grains to grains can be considered as two-phase porous media. The driving forces that dominate the two-phase flow are capillary and viscous forces. Their relative magnitudes govern the two-phase distribution and flow regions. Based upon the two-phase flow regime model proposed by Lenormand, et al. (1990, 1998). For a non-wetting solid substrate surface, the capillary force can be calculated with equation (15).

$$Δ {P}_{Capillary} = \frac{2 {σ}_{lv} cos ( {θ}_{stat} )}{r} \qquad ( 15 )$$

where σₗᵥ is the surface tension of probe liquid, ΔP_{capillary} is the difference of capillary tube pressure.

Based upon the fitted equations in FIGS. 7a and 7b, a series of surface property parameters for the selected coating surfaces were calculated. The calculated results are listed in Table 8. If all parameters listed in the equations (15) kept as unchanged variable except that contact angle (θ) measured, then, ΔP viscos is a constant. The force for driving the fracturing fluid moving will be ΔP capillary that is uniquely determined by the contact angle θ_{stat.} The % drag-force were calculated as equation (16):

$$\% DR = \frac{cos ( {θ}_{exam \text{.40} a} ) - cos ( {θ}_{exam \text{.40} c} )}{cos ( {θ}_{exam \text{.40} c} )} \qquad ( 16 )$$

where θ exam. 40a is the contact angle of sample coated with the coating of PMSI_2_81_1 and exam. 40c PMSI_2_54_1.

To determine the hysteresis kinetic Energy, the expression of equation 17 were used:

ΔE=σₗᵥ{ cos(θ−Δθ)−cos(θ+Δθ)} (17)

where σₗᵥ is the surface tension of probe liquid, ΔE is the hysteresis energy difference for the specific solid and liquid interface (HED).

The calculated % DR is 38% of less pressure needed for the proppants coated with disclosed coating of PMSI_2_81-1 than using standard fracturing fluid recipes to effectively flow through the pumped fracturing fluid for water fracturing operation. For crude oil production (assume that corn oil is a representative oil to Crude oil), the % DR is 17% less demand on pumping pressure. Clearly, the coating made the surface of coated proppants hydrophobic and less frictional. It has a sliding angle of 116° as its hysteresis contact angle equivalent to zero at microdroplet wt.=0.0246 (g). It is more compatible with corn oil than water. The applicants believe that the coated proppants provide an excellent shielding effect on the potential scaling and skinning to the flow media with its no-wetting and anti-fouling surface. The Hysteresis contact energy difference predicted by sliding angle (SA) listed in table 8 demonstrated that minimum of 9.56 (dynes/cm) of interface kinetic energy (H_ΔE) was needed for PMSI_2_54_1 recipe coated on the proppant surface. In contrast, the hysteresis kinetic energy for PMSI_2_81_1 was zero.

TABLE 8
Predicted Surface Properties and % Drag-Force Reduction of Selected Coating (PMSI_2_81_1)
Over Prepared with Standard Fracturing Fluid (Example 1)

| | | | | | | Micro- | | | | | |
|---|---|---|---|---|---|---|---|---|---|---|---|
| RUN | | | Regression Equation | | Probe | droplet | SA(α) | CA(stat.) | CHA Δθ | | H_(ΔE) |
| ID | Sample ID | Assumption | (FIG. 7a & 7b) | r² | Liquid | Wt (g) | (°) | (°) | (°) | % DR | (***) |
| 1 | Example | | SA( α, PMSI_2_81_1) | 0.912 | Water | 0.0246 | 116.0 | 63.9 | 0.0 | | |
| | 40a | | PL(W) = 0.7463x^{-1.362} | | | | | | | | |
| 2 | | | SA( α, PMSI_2_81_1) | 0.862 | Corn Oil | 0.0149 | 19.5 | 33.9 | 0.0 | | |
| | | | PL(CO) = −141.5x + 21.61 | | | | | | | | |
| 3 | | | CA( α, PMSI_2_81_1) | 0.698 | Water | 0.0246 | 116.0 | 63.9 | 0.0 | −38 | |
| | | | PL (W) = −5377x² + 566x + 53.2 | | | | | | | | |
| 4 | | | CA( α, PMSI_2_81_1) | 4E−04 | Corn Oil | 0.0149 | 19.5 | 33.9 | 0.0 | −17 (**) | |
| | | | PL (CO) = −2.18x + 33.94 | | | | | | | | |
| 5 | Example | Δθ = 0 | Δθ (PMSI_2_81_1) PL(W) = | 0.841 | Water | 0.0246 | 116.0 | 63.9 | 0.0 | | |
| | 40b | | 540.8x − 13.334 | | | | | | | | |
| 6 | | Δθ = 0 | Δθ (PMSI_2_81_1) PL(CO) = | 0.868 | Corn Oil | 0.0149 | 19.5 | 33.9 | 0.0 | | 0 |
| | | | 587.5x − 8.74 | | | | | | | | |
| 7 | Example | | SA( α, PMSI_2_54_1) PL(W) = | 0.798 | Water | 0.0246 | | | | | |
| | 40c | | 1.58x^{-0.956} | | | | | | | | |
| 8 | | | Δθ (PMSI_2_54_1) PL(W) = | 0.841 | Water | 0.0246 | | | | | |
| | | | 197.08x + 0.5291 | | | | | | | | |
| 9 | | | CA(PMSI_2_54_1) PL(W) = | 0.08 | Water | 0.0246 | 54.6 | 44.73 | 5.38 | 0 | 9.56 |
| | | | −123.8x + 44.73 | | | | | | | | |

Note:(*): CHA = calculated hysteresis angle (Δθ)(**): Assume that the corn oil can wet out the PMSI_2_54 surface 100% and have a contact angle close to zero.
(***): H_(ΔE): Hysteresis Interface Energy = 72.6 *{cos (θ − Δθ) − cos(θ + Δθ)} in a unit of Dynes/cm.

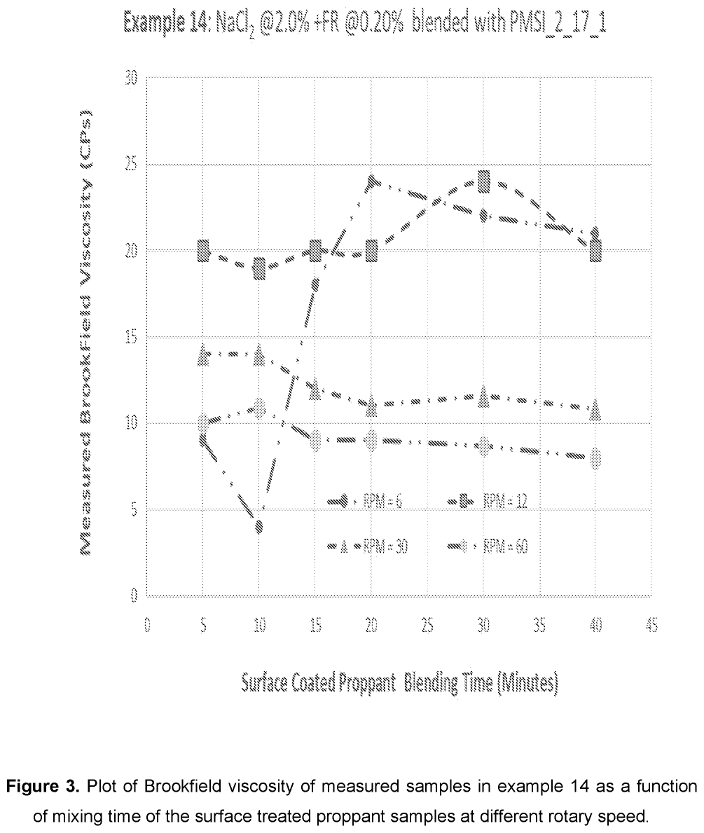

The cradle and micro-pinhole texture of the coatings are clearly shown in FIG. 3. The applicants believe that one of key contributions from waxy or other hydrophobic domains is that these texture and cradle tend to introduce air and bubble components in the measured contact angle. To simply the interfacial contribution to the fracturing fluid contribution, if it is assumed that the microdroplet will be set on a smooth solid surface with 100% waxy components, the static contact angle of the measured solid surface will be around 112° (Mdsalih, et al. 2012). As predicted in table 8, the sliding angle of coated surface is 116° as the CHA (Δθ)=0. Although the static contact angle of the microdroplet of water is less than 90° at 63.9°, the coating is hydrophobic in nature with a sliding angle of 116°. Different from the lotus leaf, the microdroplet at a total weight of 0.0246 (g) was pinned without rolling down the slit surface until it reached to a α=116° or more.

As shown in FIG. 8a, the sliding angle (SA) α is a function of microdroplet weight. The balanced static contact angle varies much less than SA as the size of microdroplets changes. A large droplet will dramatically reduce the SA if the water is used as a probe liquid. In contrast, less change of SA occurs if corn oil as probe liquid. In addition, as shown in FIG. 8b, the hysteresis of contact angle becomes large due to the increased contact area of probe liquid with the solid substrates, which can be contributed to the increased contribution of surface topographic morphology.

An interesting phenomenon as shown in FIG. 8b occurs at microdroplet weight of 0.040 (g). The hysteresis contact angles (Δθ) for both coated surface with PMSI_2_81_1 and PMSI_2_54_1 are equivalent to 8.23° at the microdroplet wt. of 0.040 (g). Below the microdroplet of 0.040 (g), the hysteresis contact angle and kinetic energy coming from PMSI_2_54_1 is larger than PMS_2_81_1. The chemical compositions and molecular structure of hydrogel polymers and its mixed components of sodium chloride cations are the dominant factors that control the coating interface behavior in term of sliding angle variation. On the other hand, as the microdroplet wt. is larger than 0.040 (g), the roughness and introduced hydrophobic domains such as wax particle bumps and ridges are the dominant factors that control the hysteresis of contact angle and interface kinetic energy. More specifically, interaction between the corn oil and tested PMSI_2_81_1 coating was primarily dominated by spreading action of oil on the substrate. In contrast, in the case of water as probe liquid for the contact angle measurement, both spreading and swelling occur simultaneously.

Based upon the disclosure present here, it is therefore demonstrated that the objects of the present invention are accomplished by the chemical composition and specified multi-functional coatings and compositions of matter and methods of preparations, its applications, and identified benefits for the hydraulic fracturing operation in oil and gas industries disclosed herein, it showed to be understood that the selection of the specified lubricant, micro-nano-textured particles and phase transition materials, emulsifiers, hydrogel polymers, and cross-linking agent, and made-up water/polar solvent percentage by wt. can be determined by one having ordinary skill in the art without departing from the spirit of the invention herein disclosed and described. It should therefore be appreciated that the present invention is not limited to the specific embodiments described above, but includes variation, modification, and equivalent embodiments defined by the following claims.

### REFERENCE CITED

Assefa, K. M. & D. R. Kansha, 2015, A comparative study of friction factor correlations for high concentrate slurry flow in smooth pipes. J. Hydrol. Hydromech., 63, 2015, 1, 13-20.
Miwa, M., A. Nakajima, A. Fujishima, K. Hashimoto, and T. Watanabe, 2000, Effects of the surface roughness on sliding angles of water droplets on superhydrophobic surfaces. Langmuir 16, 5754-5760.
Mdsalih, N., U. Hashim, N. Nafarizal, C. F. Soon, M. Sahdan, 2012, Surface tension analysis of cost-effective paraffin wax and water flow simulation for microfluidic device. Advanced Materials Research, ISSN: 1662-8985, Vol. 832, pp 773-777. Online: 2013-11-21.
Liu, F. P., D. Gardner, M. Wolcott, 1995, A model for the description of polymer surface dynamic behavior 1. contact angle vs. surface properties, Langmuir 1995, 1 (7), 2674-2681.
R. Lenormand, E. Touloul, C. Zarcone, J. Fluid Mech., 165, 189 (1998).
R. Lenormand, J. Phys. Cordes, Matter 2, 1990, SA 79.
U.S. Patent Application 2011/0245113
U.S. Patent Application, 20120190593
U.S. Patent Application, 20150252253
U.S. Patent Application, 20150252252
U.S. Patent Application, 20180155614
U.S. Patent Application, 20180119006
U.S. Patent Application, 20190093000
U.S. Patent Application, 20190002756
U.S. Patent Application, 20190010387
U.S. Pat. No. 3,943,060
U.S. Pat. No. 5,948,733
U.S. Pat. No. 8,661,729
U.S. Pat. No. 9,868,896
U.S. Pat. No. 10,023,790
U.S. Pat. No. 10,316,244
U.S. Pat. No. 10,208,628
U.S. Pat. No. 10,144,865
U.S. Pat. No. 9,783,628
U.S. Pat. No. 9,701,883
U.S. Pat. No. 9,963,597
U.S. Pat. No. 10,011,860
U.S. Pat. No. 10,221,321
U.S. Pat. No. 10,233,334

We claim:

1) Chemical composition or/and coatings are comprising of by percentage weight:
a. liquid lubricant or/and non-polar solvent from 1% to 99%
b. micro-nano/textured dot dual phobic domains from 0.01 to 40%
c. hydrogel polymers: 0.001 to 35%
d. surfactant or/and emulsifiers: 0.005 to 20.0%
e. water as solvent: 1.0% to 99.0%
f. a combination of the above components as a coating featured with anti-blocking and anti-sticking from grains to grains in the material's handling processes in which a drying operation on wet sand and granular particles coated with the disclosed coating becomes unnecessary or redundant.

2) The chemical composition of claim 1, wherein the lubricant or/and non-polar solvent is mineral oil, saturated hydrocarbon, alkyl chains of ethylene carbon, liquid paraffin, kerosene, petroleum distillates, and higher alkanes, cyclo-alkanes, the alkyl carbon chain from C6 to C20, the dosage levels of the lubricant or/and non-polar solvent is ranged from 1% to 99% over the total percentage by weight.

3) The chemical composition of claim 1, wherein the chemical compositions of micro-nano/textured dot dual phobic domains are candle wax, paraffin wax, slick wax, or ethylene stearamide, bis-stearamide synthesis wax, carnauba wax, natural organic and organic synthesized wax that have a melting point of at least 35° C. or above, or/and biomaterials or their derivatives such as sweet rice floor, soy wax, soy protein isolate (SPI) particles, soy protein concentrates, or/and its derivatives from SPI functionalized with amine or hydroxyl, carboxyl, and aldehyde, ester, amide and polyamide functionalities, or/and the combination of petroleum based or bio-based materials, polylactic acid ester, inorganic particles such as modified hydrophobic/hydrophilic silica particles, or the combination of organic and inorganic particles, therefore, the dosage level of these hydrophobic/hydrophilic domain's materials is ranged from 0.01% to 40%.

4) The chemical composition of claim 1, wherein the hydrogel polymers are polyacrylate anionic, or cationic, or nonionic polymers or hydrolyzed acrylate sodium acrylamide polymers, the mixed combination of these polymers and their copolymers functionalized with functional groups of amine, hydroxyl, and carboxyl, and aldehyde, sulfonate, and cyclic amine and vinyl functional groups, having linear, or/and branded, or/and dendrimer's structure, the dosage level of hydrogel polymers is ranged from to 35% by weight percentage over the total weight, preferred less than 15.0%, more preferred less than 5%.

5) The chemical composition of claim 1, wherein the emulsifiers are linear, di-, tri- or multi-branched surfactants, with cationic, anionic, amphoteric, nonionic, and zwitterionic surfactants and/or their combination therefore, the total dosage level of surfactant/emulsifiers is ranged from 0.001 to 20.0%, preferred less than 3.0%.

6) The chemical composition of claim 3 or/and its combination with claim 4, wherein it is modified by cross-linking additive chemicals containing reactive functional groups, such as isocyanate, epoxy, unsaturated ethylene double bonds, amide, imide, silane, aldehyde, amine, and carboxylic acid, et al., that can cross-link the hydrogel polymer into flexible and elastic network structure and polyamido-amine epichlorohydrin (PAE) into a wet strength polymer network, the cross-linking additives could be added as mixed with others pre-added, simultaneously, or post-added, the dosage level of cross-linking agents is ranged from 0.0% to 200% over claim 3 or/and their combined percentage of weight as 100% base weight.

7) The chemical composition of claim 3, wherein, it is mixed with additives containing antimicrobial agent and compounds, and/or anti-fermentation agents, such as glutaraldehyde, sodium bicarbonate, fatty amine, or zwitterionic surfactants, benzyl-c12-16-dimenthyl ammonium chloride, biocide 2,2-dibromo-3-Nitripronanioe (DBNPA), copper oxide nano-particles, copper sulfate solution, the dosage levels of the antimicrobial agents are ranged from 0 to 200% over the claim 3 additives by weight percentage, preferred less than 100.0%, or less than 1.0%.

8) The chemical composition of claim 1, wherein, the liquid lubricant or mineral oil of claim 2 is added into a container first, then, the composition of claim 3 charged into the container following pre-determined wt. percentage, the blended components from lubricant/mineral oil with domain materials are stirred and heated to 140° F. or above, alternatively, cross-linking agents of claim 6 or antimicrobial agents of claim 7 are added into the mixed components of mineral oil and domain materials to achieve desirable synergy or post added into the mixture.

9) The chemical composition of claim 8, wherein, the hydrogel gel polymer of claim 4 and surface emulsifiers of claim 5 are added into the mixed components of claim 8 in a sequence or simultaneously after all of components are blended uniformly at a solution temperature of above 140° F. or so.

10) The chemical composition of claim 9, wherein, water or other polar solvent is added to adjust the viscosity of the mixed components into a hydrated viscosity within a range by wt. percentage from 1.0 (cP) to 50,000 (cP), preferred hydrated viscosity less than 100 (cP), more than 50.0 (cP), more than 20 (cP).

11) The chemical composition of claim 10, wherein, the solid content of the mixed components measured is within a range by weight percentage from 0.5% to 60.0%, preferred less than 10.0%, more preferred less than 5.0%.

12) The chemical composition of claim 11, wherein, it is used as an emulsion to coat on a solid substrate, directly through spraying nozzles or mixed in a rotary mixer, including proppants, frac sand, ceramics, bauxite, glass spherical particles, walnut shell particles, silica particles and surface modified particles materials.

13) The chemical composition of claim 11, wherein, a friction reducer in powder or liquid solution can be pre-blended or post blended, or simultaneously blended with claimed proppants in claim 12, then, the chemical composition of claim 11 or mixture of friction reducer and claimed coating 11 is coated on the proppant surface within a range from 0 to 6.0%, preferred less than 3.0%, or preferred less than 1.5%, 1.0% on the friction reducer to the proppants.

14) The chemical composition of claim 11, wherein, the coating as chemical additives can be directly added into water as frac fluid agent or diluted with water in a ratio of claimed emulsion chemicals of claim 11 to water from 20:80 and 100:0, preferred within a range from 30:70 and 50:50 in the downhole condition.

15) The chemical composition of claim 13, wherein, the coated proppants can reduce the respirable microcrystalline silica dust concentration by more than 95.0% in comparison with the untreated proppants, preferred by 97.0%, 98.0%, 99.0%, 99.50%, and 99.95%.

16) The chemical composition of claim 13, wherein, it can be blended with other fracturing fluid additives to provide increased hydrated viscosity, preferred dose level of the emulsion into fracturing fluid by wt. from 0 to 50%, preferred less than 40.0%, more preferred less than 25.0%.

17) The chemical composition of claim 11, wherein, it can be blended with high salinity frac water, or reused product water, or/and wasted frac fluid with increased frac fluid viscosity within a range of salt content (sodium chloride) from 0.01% to 26% by w/w at a regular ambient temperature of 25 OC.

18) The chemical composition of claim 11, wherein, it can sustain a high well bottomhole temperature from 30° C. to 200° C.

19) The chemical composition of claim 11, wherein, the coated proppants mixed with fracturing fluids can reduce the pumping pressure by more than 25%, preferred 50%, more preferred more than 70% pumping pressure reduction.

20) The chemical composition of claim 13, wherein, friction reducer in powder can be blended or added with claimed coating of claim 20. The preferred dose level of added friction reducer in powder by wt. percentage over proppants within a range of from 0.0% to 1.50%, preferred 0.25% to 1.15% over proppant weight.

21) The chemical composition of claim 13, wherein, the water absorbed rate of coated proppants is swollen as high as more than 30.0% useful for reducing water usage, preferred than 35.0%.

22) The chemical composition of claim 13, wherein the pH value can be adjusted from 2.0 to 13.0, preferred more than 7.0 and less than 9.0.

23) The chemical composition of claim 11, wherein, the dried coating on the glass substrate has a sliding contact angle of larger than 70° without rolling down the tilted flatten surface, not less than 90 degree, characterized as a hydrophobic coating profiled by micro-nano/textured morphology having a pinning of water droplet with sliding contact angle less than 130 degree, preferred less than 120 degree at a water microdroplet weight of not less than 0.0246 (g), alternatively, the coating is also a hydrophilic coating by which the contact angle of the coatings to water less than 90 (degree), resulting in a hydro-dual-phobic coating surface of the proppants.
